(19) United States
(12) Patent Application Publication
(10) Pub. No.: US 2026/0051080 A1
(43) Pub. Date: Feb. 19, 2026

(54) ELECTRONIC APPARATUS AND CONTROL METHOD THEREOF

(71) Applicant: SAMSUNG ELECTRONICS CO., LTD., Suwon-si (KR)

(72) Inventors: Oanh Tien LE, Hanoi (VN); Huy Quang LE, Hanoi (VN); Toan Van LY, Hanoi (TW)

(73) Assignee: SAMSUNG ELECTRONICS CO., LTD., Suwon-si (KR)

(21) Appl. No.: 19/301,441

(22) Filed: Aug. 15, 2025

Related U.S. Application Data
(63) Continuation of application No. PCT/KR2025/006395, filed on May 12, 2025.

(30) Foreign Application Priority Data
Aug. 14, 2024 (KR) 10-2024-0109209

(51) Int. Cl. G06T 9/00; G06T 5/50; G06T 7/11; H04N 1/60

(52) U.S. Cl. CPC G06T 9/00; G06T 5/50; G06T 7/11; H04N 1/6016; G06T 2207/20221

(57) ABSTRACT

An electronic apparatus may include memory storing instructions, and at least one processor, wherein the instructions that, when executed by the at least one processor, cause the electronic apparatus to: obtain a video frame of a first color space and a user interface (UI) frame of a second color space; identify a video region corresponding to the video frame and a UI region corresponding to the UI frame from a display region in which the video frame and the UI frame are displayed; identify a non-overlap video region from the video region that does not overlap the UI region; identify an overlap video region from the video region that overlaps the UI region; obtain first encoding data by encoding the non-overlap video region; obtain combining data by combining the overlap video region and the UI frame; and obtain second encoding data by encoding the combining data.

### CROSS-REFERENCE TO RELATED APPLICATIONS

This application is a bypass continuation of International Application No. PCT/KR2025/006395, filed on May 12, 2025, which is based on and claims priority to Korean Patent Application No. 10-2024-0109209, filed on Aug. 14, 2024, in the Korean Intellectual Property Office, the disclosures of which are incorporated by reference herein in their entireties.

### BACKGROUND

### 1. Field

The disclosure relates to an electronic apparatus and a control method thereof, and more particularly, to an electronic apparatus merging a video frame and a user interface (UI) frame and a control method thereof.

### 2. Description of Related Art

Screens output through a display or a projection lens may include a plurality of layers. A screen may be output based on a coupling (combining) of layers indicating a video frame and a layer indicating a UI frame. A user may visually recognize one screen in which the video frame and the UI frame are coupled.

The screen visually recognized by the user may be generated based on data including both the video frame and the UI frame. An electronic apparatus may perform a video processing operation to generate a screen in which the video frame and the UI frame are coupled.

The video processing operation may include an operation of coupling different sources of images (or image frames). The video processing operation may include a layer coupling operation. In the case in which the video processing operation is performed, processing time may be required.

In the technical field in which the video processing operation is performed in real time, the generation of a screen may be delayed. The user may feel inconvenience due to a screen stutter or a low screen response.

### SUMMARY

Provided are an electronic apparatus partially generating encoding data by coupling an overlap region of a video frame and a UI frame, considering whether the video frame and the UI frame overlap, and a control method thereof.

According to an aspect of the disclosure, an electronic apparatus may include: memory configured to store instructions; and at least one processor including processing circuitry, wherein the instructions, when executed by the at least one processor individually or collectively, cause the electronic apparatus to: obtain a video frame of a first color space and a user interface (UI) frame of a second color space; identify a video region corresponding to the video frame and a UI region corresponding to the UI frame from a display region in which the video frame and the UI frame are displayed; identify a non-overlap video region from the video region that does not overlap the UI region; identify an overlap video region from the video region that overlaps the UI region; obtain first encoding data by encoding the non-overlap video region; obtain combining data by combining the overlap video region and the UI frame; obtain second encoding data by encoding the combining data; obtain final encoding data by merging the first encoding data and the second encoding data.

The instructions, when executed by the at least one processor individually or collectively, may further cause the electronic apparatus to: divide the video frame and the UI frame into a plurality of blocks; and based on the plurality of blocks, identify the video region and the UI region.

The instructions, when executed by the at least one processor individually or collectively, may further cause the electronic apparatus to: identify a first ratio occupied by the video region in the display region; identify a second ratio occupied by the UI region in the display region; obtain a target ratio by dividing the first ratio by the second ratio; and based on the target ratio, obtain the combining data.

The instructions, when executed by the at least one processor individually or collectively, may further cause the electronic apparatus to: based on the target ratio being equal to or greater than a threshold ratio, identify whether video rendering of converting the second color space into the first color space is possible; based on the video rendering being possible, obtain the combining data by applying the video rendering to the UI frame; and based on the video rendering being impossible, obtain the combining data by applying UI rendering to the UI frame.

The instructions, when executed by the at least one processor individually or collectively, may further cause the electronic apparatus to: based on the video rendering being possible, obtain a first rendering UI frame by performing the video rendering on the UI frame; and obtain the combining data by combining the overlap video region and the first rendering UI frame.

The instructions, when executed by the at least one processor individually or collectively, may further cause the electronic apparatus to: based on the video rendering being impossible, obtain a second rendering UI frame by performing the UI rendering on the UI frame; obtain a converting UI frame by performing a first color space conversion on the second rendering UI frame; and obtain the combining data by combining the overlap video region and the converting UI frame.

The first color space conversion may include converting pixel information of the second color space into pixel information of the first color space.

The instructions, when executed by the at least one processor individually or collectively, may further cause the electronic apparatus to: identify whether the video frame is a 2D image; and based on the video frame being not a 2D image, perform 2D modeling on the video frame.

The first color space may be YUV or YUVA, and the second color space may be RGB or RGBA.

The electronic apparatus may further include: a communication interface connected to an extended reality (XR) device. The instructions, when executed by the at least one processor individually or collectively, may further cause the electronic apparatus to transmit the final encoding data to the XR device through the communication interface.

According to an aspect of the disclosure, a control method of an electronic apparatus, may include: obtaining a video frame of a first color space and a user interface (UI) frame of a second color space; identifying a video region corresponding to the video frame and a UI region corresponding to the UI frame from a display region in which the video frame and the UI frame are displayed; identifying a non-overlap video region from the video region that does not overlap the UI region; identifying an overlap video region from the video region that overlaps the UI region; obtaining first encoding data by encoding the non-overlap video region; obtaining combining data by combining the overlap video region and the UI frame; obtaining second encoding data by encoding the combining data; obtaining final encoding data by merging the first encoding data and the second encoding data; and transmitting the final encoding data to a device for displaying an image based on the final encoding data.

The identifying the video region and the UI region may include: dividing the video frame and the UI frame into a plurality of blocks; and based on the plurality of blocks, identifying the video region and the UI region.

The method may further include: identifying a first ratio occupied by the video region in the display region; identifying a second ratio occupied by the UI region in the display region; and obtaining a target ratio by dividing the first ratio by the second ratio. The obtaining the combining data may include obtaining the combining data based on the target ratio.

The method may further include: based on the target ratio being equal to or greater than a threshold ratio, identifying whether video rendering of converting the second color space into the first color space is possible. The obtaining the combining data may further include: based on the video rendering being possible, obtaining the combining data by applying the video rendering to the UI frame; and based on the video rendering being impossible, obtaining the combining data by applying UI rendering to the UI frame.

The obtaining the combining data may further include: based on the video rendering being possible, obtaining a first rendering UI frame by performing the video rendering on the UI frame; and obtaining the combining data by combining the overlap video region and the first rendering UI frame.

The obtaining the combining data may further include: based on the video rendering being impossible, obtaining a second rendering UI frame by performing the UI rendering on the UI frame; obtaining a converting UI frame by performing a first color space conversion on the second rendering UI frame; and obtaining the combining data by combining the overlap video region and the converting UI frame.

The first color space conversion may include converting pixel information of the second color space into pixel information of the first color space.

The method may further include: identifying whether the video frame is a 2D image; and based on the video frame being not a 2D image, performing 2D modeling on the video frame.

The first color space may be YUV or YUVA, and the second color space may be RGB or RGBA.

The method may further include: transmitting the final encoding data to an extended reality (XR) device through a communication interface connected to the XR device.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view provided to explain an operation of coupling a video frame and a UI frame, according to an embodiment;

FIG. 2 is a block diagram illustrating an electronic apparatus, according to an embodiment;

FIG. 3 is a block diagram provided to explain a detailed configuration of the electronic apparatus of FIG. 2, according to an embodiment;

FIG. 4 is a view provided to explain a 2D video processing structure, according to an embodiment;

FIG. 5 is a view provided to explain a 3D video processing structure, according to an embodiment;

FIG. 6 is a view provided to explain a color space conversion operation, according to an embodiment;

FIG. 7 is a view provided to explain an operation of obtaining a target ratio by identifying a video region and a UI region and, according to an embodiment;

FIG. 8 is a view provided to explain an operation of dividing a window buffer and a frame buffer, according to an embodiment;

FIG. 9 is a view provided to explain an operation of identifying a video region and a UI region, according to an embodiment;

FIG. 10 is a view provided to explain a frame in which a video region occupies a greater ratio than a UI region, according to an embodiment;

FIG. 11 is a view provided to explain a frame in which a UI region occupies a greater ratio than a video region, according to an embodiment;

FIG. 12 is a view provided to explain an operation of performing a different operation based on a target ratio, according to an embodiment;

FIG. 13 is a view provided to explain an operation of obtaining final encoding data in a case where a target ratio is equal to or greater than a threshold ratio, according to an embodiment;

FIG. 14 is a view provided to explain an operation of obtaining final encoding data in a case where video rendering is possible, according to an embodiment;

FIG. 15 is a view provided to explain an operation of obtaining final encoding data in a case where video rendering is impossible, according to an embodiment;

FIG. 16 is a view provided to explain an operation of determining whether video rendering is possible, according to an embodiment;

FIG. 17 is a view provided to explain an operation of determining a processing unit performing a coupling operation, according to an embodiment;

FIG. 18 is a view provided to explain an operation of processing an alpha value in a coupling operation, according to an embodiment;

FIG. 19 is a view provided to explain an operation of obtaining final encoding data in a case where a target ratio is less than a threshold ratio, according to an embodiment;

FIG. 20 is a view provided to explain an operation of obtaining final encoding data in a case where a target ratio is less than a threshold ratio, according to an embodiment;

FIG. 21 is a view provided to explain an operation of updating a PNSR table through a screen output from an XR device, according to an embodiment;

FIG. 22 is a view provided to explain an operation of updating a PSNR table based on a lookup table transmitted from an external display device, according to an embodiment;

FIG. 23 is a view provided to explain an operation of selecting a processing unit performing a coupling operation based on perpendicular synchronization time, according to an embodiment; and

FIG. 24 is a view provided to explain a control method of an electronic apparatus, according to an embodiment.

### DETAILED DESCRIPTION

Hereinafter, the subject matter of the present disclosure is described in detail with reference to the accompanying drawings.

General terms currently widely used are selected as the terms used in the embodiments of the disclosure in consideration of their functions in the disclosure, but may be changed based on the intention of one skilled in the art or a judicial precedent, the emergence of a new technology, or the like. In addition, in a specific case, terms arbitrarily chosen by the applicant may be included in the terms used herein. In this case, the meanings of such terms are provided in detail in the corresponding descriptions of the disclosure. Therefore, the terms used in the embodiments of the disclosure need to be defined on the basis of meanings thereof and overall details throughout the disclosure rather than simply names thereof.

In the disclosure, the expression “have”, “may have”, “include”, “may include” or the like, indicates the existence of a corresponding feature (e.g., a numerical value, a function, an operation or an element such as a part), and does not exclude the existence of an additional feature.

The expression “at least one of A or B” is to be understood as indicating “A” or “B” or “A and B”.

The expression “1st”, “2nd”, “first”, “second”, or the like, used in the disclosure, may be used to modify various elements regardless of their order and/or importance, and may be used merely to differentiate one element from another but not be intended to limit corresponding elements.

Based on one element (e.g., a first element) referred to as being “(operatively or communicatively) coupled with/to” or “connected with/to” another element (e.g., a second element), it is to be understood that one element may be connected to another element directly, or through yet another element (e.g., a third element).

Throughout the disclosure, singular forms include plural forms as well, unless explicitly indicated otherwise. In the disclosure, the term “include” or “composed of” and the like specify the presence of stated features, integers, steps, operations, elements, components or combinations thereof but do not imply the exclusion of the presence or addition of one or more other features, integers, steps, operations, elements, components or combinations thereof.

In the disclosure, the term “module” or “unit” may perform at least one function or operation, and be implemented by hardware or software or by a combination of hardware and software. In addition, a plurality of “modules” or a plurality of “units” may be integrated into at least one module and be implemented by at least one processor except for a “module” or a “unit” that needs to be implemented by specific hardware.

In the disclosure, the term “user” may refer to a human using an electronic apparatus or an apparatus using an electronic apparatus (e.g., an artificial intelligence electronic apparatus).

Hereinafter, one embodiment of the present disclosure is described in greater detail with reference to the accompanying drawings.

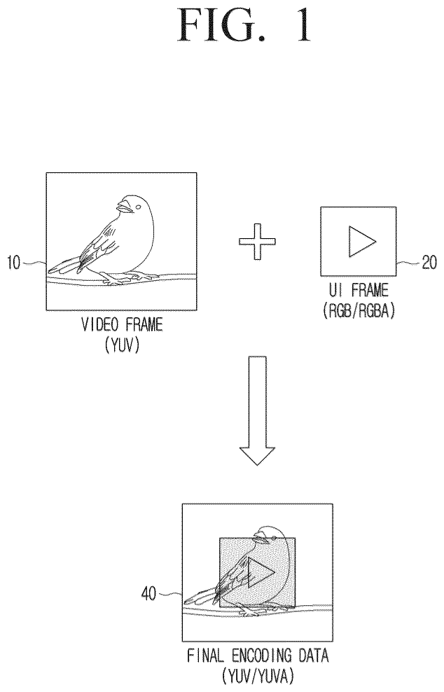

FIG. 1 is a view provided to explain an operation of coupling (combining) a video frame and a user interface (UI) frame, according to an embodiment.

Referring to FIG. 1, an electronic apparatus 100 may receive a video frame 10 and a UI frame 20. The electronic apparatus 100 may obtain final encoding data 40 by coupling the video frame 10 and the UI frame 20.

The video frame 10 may include pixel information expressed as a first color space. The first color space may be YUV. The YUV may denote color spaces defined as Y (luminance), U (chrominance blue) and V (chrominance red). Y may denote brightness or luminance. U may denote a value based on deducing a brightness value from a blue ingredient. V may denote a value based on deducting a brightness value from a red ingredient.

The UI frame 20 may include pixel information expressed as a second color space. The second color space may be RGB. The RGB may denote a color space defined as R (red), G (green) and B (blue).

The electronic apparatus 100 may obtain the final encoding data 40 by coupling the video frame 10 expressed as the first color space and the UI frame 20 expressed as the second color space. The final encoding data may include pixel information expressed as the first color space.

According to an embodiment, the pixel information stored in the video frame 10 may be expressed as YUVA. The YUVA may denote a color space in which A (alpha) is additionally defined in YUV. The A (alpha) may denote transparency. The A (alpha) may indicate whether a pixel is transparent or opaque.

According to an embodiment, the pixel information stored in the UI frame 20 may be expressed as RGBA. The RGBA may denote a color space in which A (alpha) is additionally defined in RGB. The A (alpha) may denote transparency. The A (alpha) may indicate whether a pixel is transparent or opaque.

In one example, the video frame 10 may be an extended reality (XR) frame. The XR frame may include a virtual reality (VR) frame, an augmented reality (AR) frame or a mixed reality (MR) frame.

In one example, the video frame 10 may be a normal video frame. Even in an electronic apparatus including a display such as a smartphone, the video frame 10 and the UI frame 20 may be coupled and displayed on one screen.

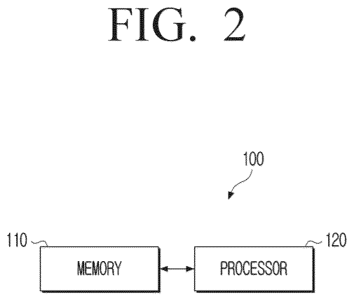

FIG. 2 is a block diagram illustrating an electronic apparatus, according to an embodiment.

Referring to FIG. 2, the electronic apparatus 100 may include at least one of memory 110 or at least one processor 120.

The electronic apparatus 100 may include memory 110 storing instructions, and/or at least one processor 120 including processing circuitry. The instructions may be executed individually or collectively by the at least one processor 120.

The electronic apparatus 100 may perform an operation of merging the video frame and the UI frame. The electronic apparatus 100 may generate a screen including the video frame and the UI frame. The electronic apparatus 100 may generate one screen by coupling a layer corresponding to the video frame and a layer corresponding to the UI frame. The electronic apparatus 100 may be an apparatus that performs the operation of merging the video frame and the UI frame.

In one example, the electronic apparatus 100 may be a server that provides a screen. The electronic apparatus 100 may receive a control instruction for generating a screen by merging the video frame and the UI frame. The electronic apparatus 100 may generate final encoding data by merging the video frame and the UI frame. The electronic apparatus 100 may transmit the final encoding data to an external device. The external device may be an XR device 200 or a display device 300.

In one example, the electronic apparatus 100 may be a terminal device. The electronic apparatus 100 may be a user terminal device (e.g., a smartphone, a tablet computer or a wearable device). The electronic apparatus 100 may transmit, to an external device, the final encoding data where the video frame and the UI frame are merged. The external device may be an XR device 200 or a display device 300. In other words, the electronic apparatus 100 may transmit the final encoding data to a device for displaying an image based on the final encoding data.

In one example, the electronic apparatus 100 may be an XR device. The electronic apparatus 100 may output a screen by merging the video frame and the UI frame. The electronic apparatus 100 may not require an encoding operation in the case where the electronic apparatus 100 is implemented as an XR device. In the case where the encoding operation is not required, encoding data hereinafter may be described as video data.

Hereinafter, an embodiment of generating the final encoding data by the electronic apparatus 100 is described.

The at least one processor 120 may obtain a video frame of a first color space and a UI frame of a second color space.

The video frame and the UI frame may be expressed as a different color space. The video frame may include pixel information of the first color space. The UI frame may include pixel information of the second color space.

Outputting the video frame and the UI frame, expressed as a different color space, as one screen is a matter of processing speed and processing time.

The at least one processor 120 may receive a control instruction for outputting the video frame and the UI frame together. The at least one processor 120 may generate encoding data for displaying the video frame and the UI frame as one screen. The at least one processor 120 may generate the encoding data in consideration of an overlap region of the video frame and the UI frame.

The at least one processor 120 may identify a video region corresponding to the video frame and a UI region corresponding to the UI frame from an entire region (or display region) in which the video frame and the UI frame are displayed.

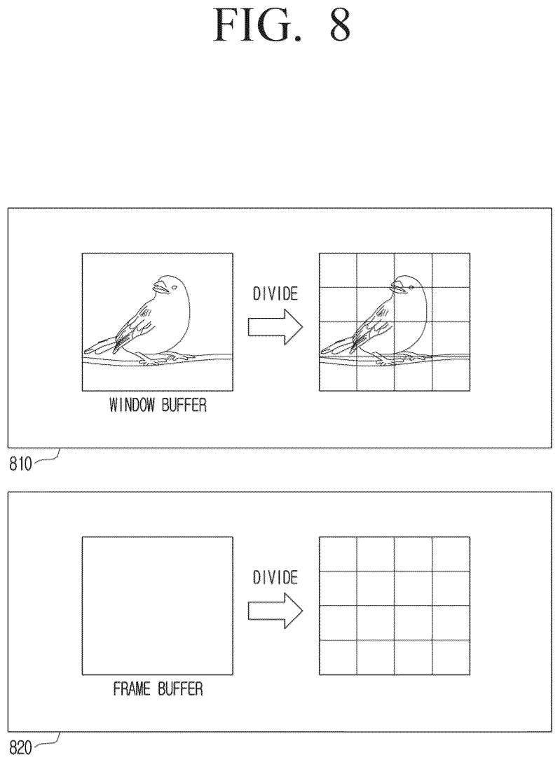

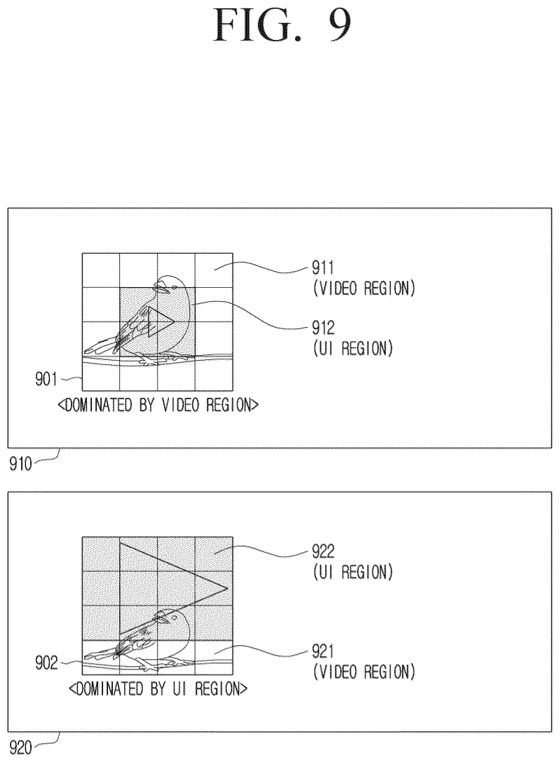

The at least one processor 120 may divide the video frame and the UI frame into a plurality of blocks, and based on the plurality of the divided blocks, identify the video region and the UI region. Descriptions in relation to this are provided with reference to FIGS. 8 and 9.

The at least one processor 120 may identify a non-overlap video region that does not overlap the UI region, from the video region. The at least one processor 120 may identify an overlap video region that overlaps the UI region, from the video region.

The at least one processor 120 may identify a region (an overlap region) in which the video region where the video frame is displayed and the UI region where the UI frame is displayed overlap each other. The at least one processor 120 may distinguish the video region as the non-overlap video region and the overlap video region.

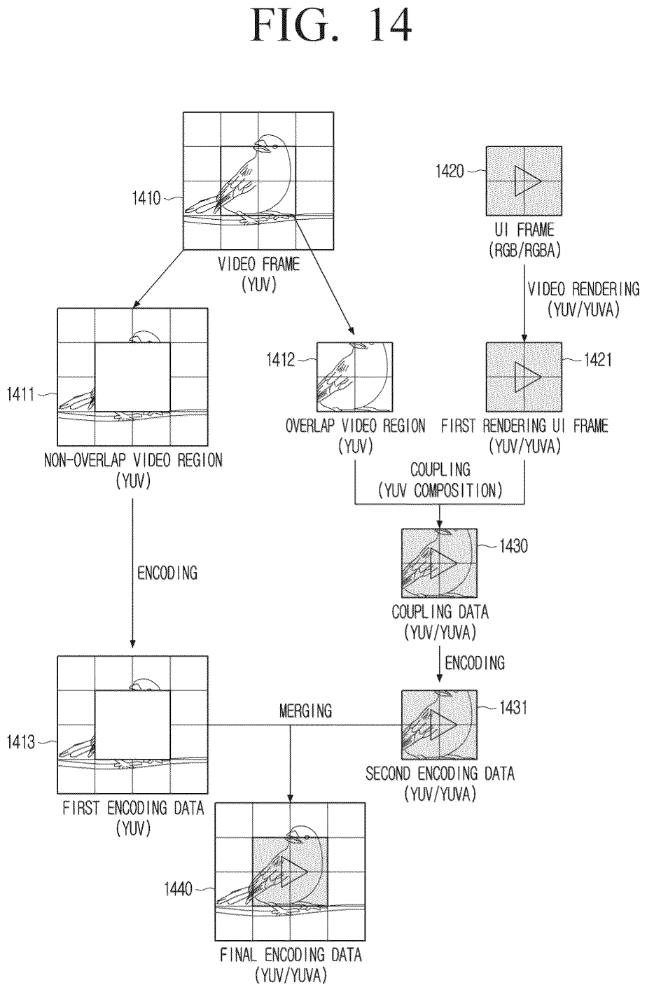

The non-overlap video region may be described as a frame corresponding to the non-overlap video region. The overlap video region may be described as a frame corresponding to the overlap video region. The region may be described as a portion or block. Descriptions in relation to the overlap region are provided with reference to FIGS. 14, 15 and 20.

The at least one processor 120 may obtain first encoding data by encoding the non-overlap video region.

The at least one processor 120 may perform a partial encoding operation on a region that does not overlap the UI region, from the video region.

The at least one processor 120 may obtain coupling data (or combining data) by coupling the overlap video region and the UI frame.

The at least one processor 120 may obtain coupling data by performing a coupling operation on the overlap video region, which is not reflected in the first encoding data, as a remaining portion, and the UI frame.

The at least one processor 120 may obtain second encoding data by encoding the coupling data.

The at least one processor 120 may obtain final encoding data by merging the first encoding data and the second encoding data.

The final encoding data may include all information on the video frame and the UI frame.

The at least one processor 120 may identify a first ratio occupied by the video region, in the entire region, and a second ratio occupied by the UI region, in the entire region. The at least one processor 120 may obtain a target ratio by dividing the first ratio by the second ratio, and based on the target ratio, obtain the coupling data.

The first ratio may be described as a video ratio. The second ratio may be described as a UI ratio. The at least one processor 120 may calculate the target ratio based on the first ratio and the second ratio.

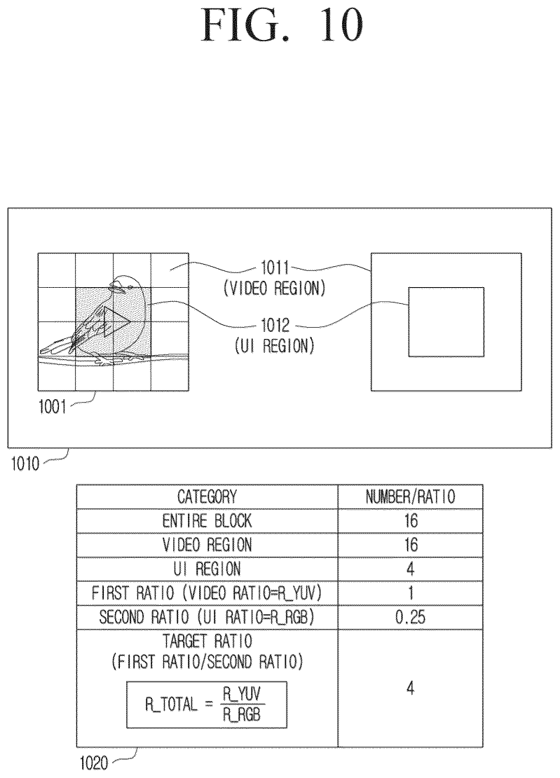

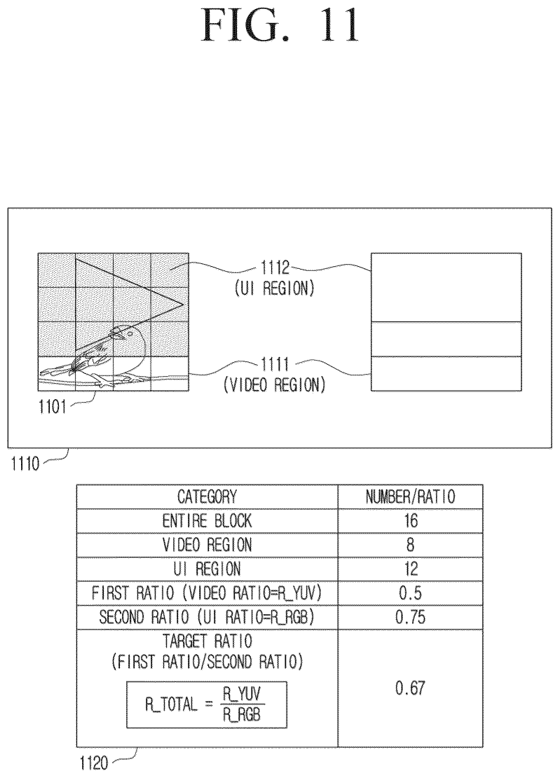

The target ratio may indicate a relationship of a ratio occupied by the video region or the UI region, in the entire region. The target ratio may indicate which of the video region and the UI region occupies a greater region, in the entire region. Descriptions in relation to the target ratio are provided with reference to FIGS. 10 and 11.

The at least one processor 120 may identify whether video rendering of converting the second color space into the first color space is possible, in the case where the target ratio is equal to or greater than a threshold ratio. The threshold ratio may be changed depending on user settings.

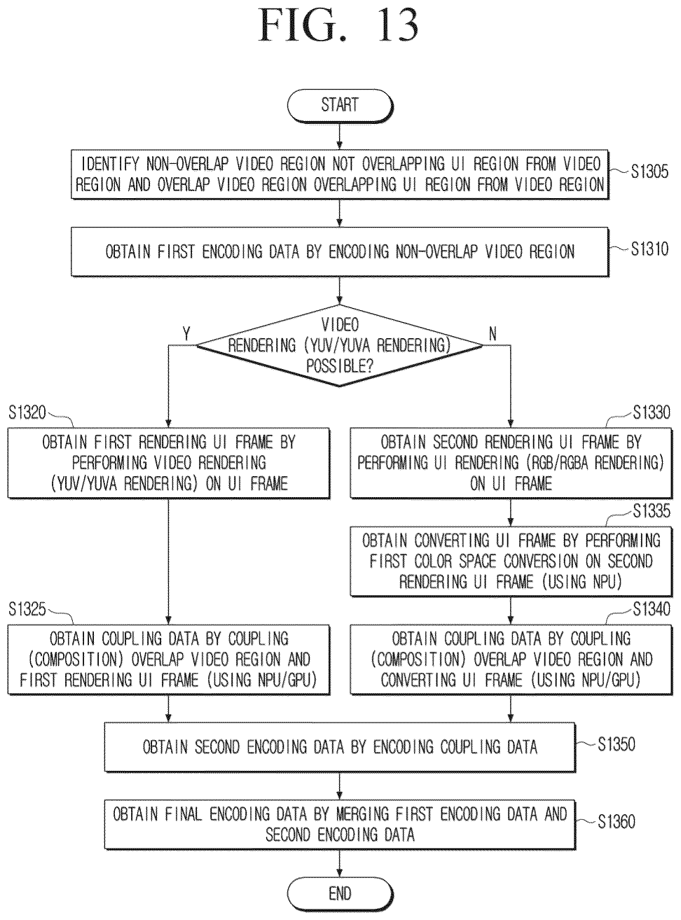

An embodiment of the target ratio being equal to or greater than the threshold ratio is described with reference to FIGS. 13-15.

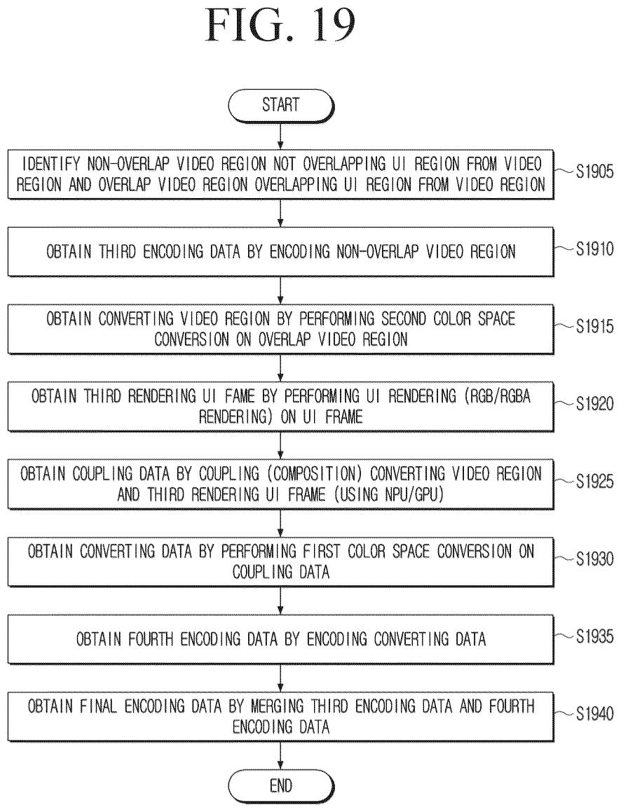

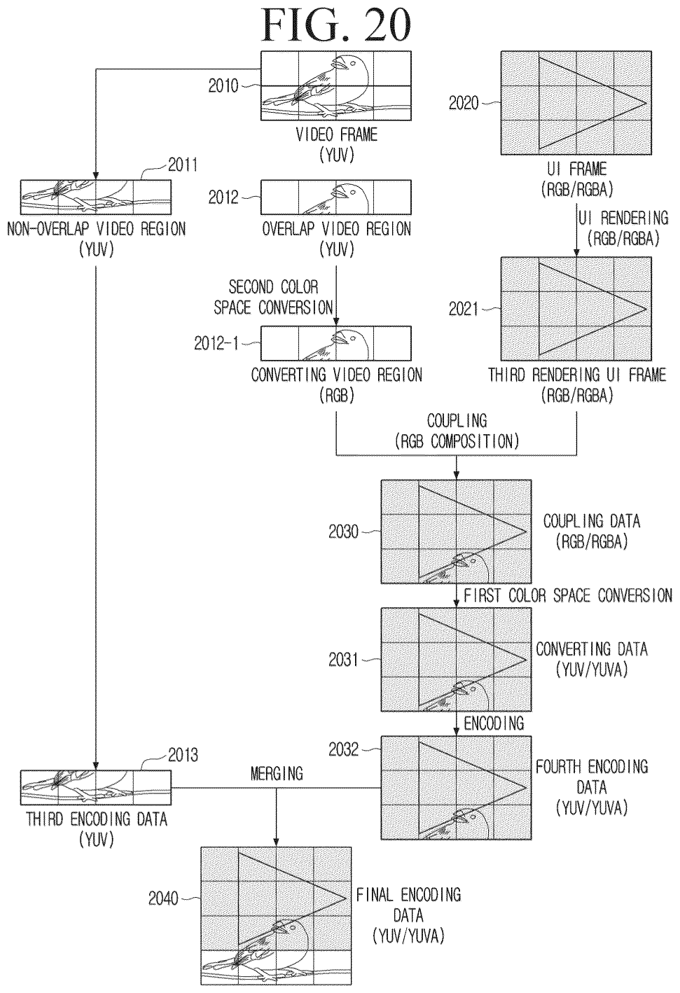

An embodiment of the target ratio being less than the threshold ratio is described with reference to FIGS. 19-20.

In the case where the video rendering is possible, the at least one processor 120 may obtain the coupling data by applying the video rendering on the UI frame.

In the case where the video rendering is possible, the at least one processor 120 may obtain a first rendering UI frame by performing the video rendering on the UI frame. The at least one processor 120 may obtain the coupling data by coupling the overlap video region and the first rendering UI frame.

An embodiment of generating the final encoding data, in the case where the video rendering is possible, is described with reference to FIG. 14.

In the case where the video rendering is impossible, the at least one processor 120 may obtain the coupling data by applying UI rendering to the UI frame.

In the case where the video rendering is impossible, the at least one processor 120 may obtain a second rendering UI frame by performing the UI rendering on the UI frame. The at least one processor 120 may obtain a converting UI frame by performing a first color space conversion on the second rendering UI frame. The at least one processor 120 may obtain the coupling data by coupling the overlap video region and the converting UI frame.

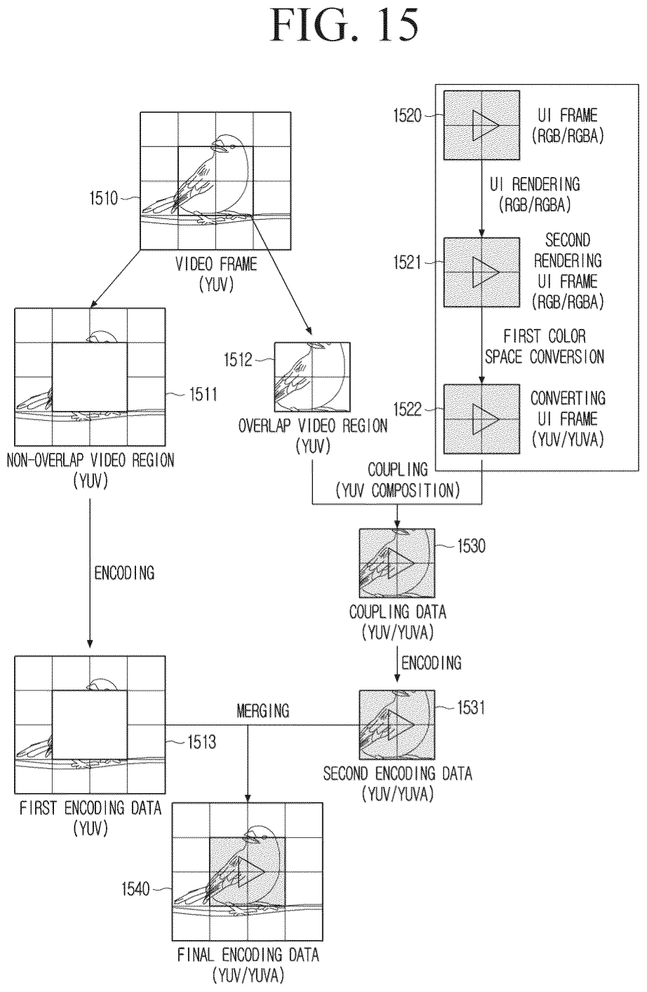

An embodiment of generating the final encoding data, in the case where the video rendering is impossible, is described with reference to FIG. 15.

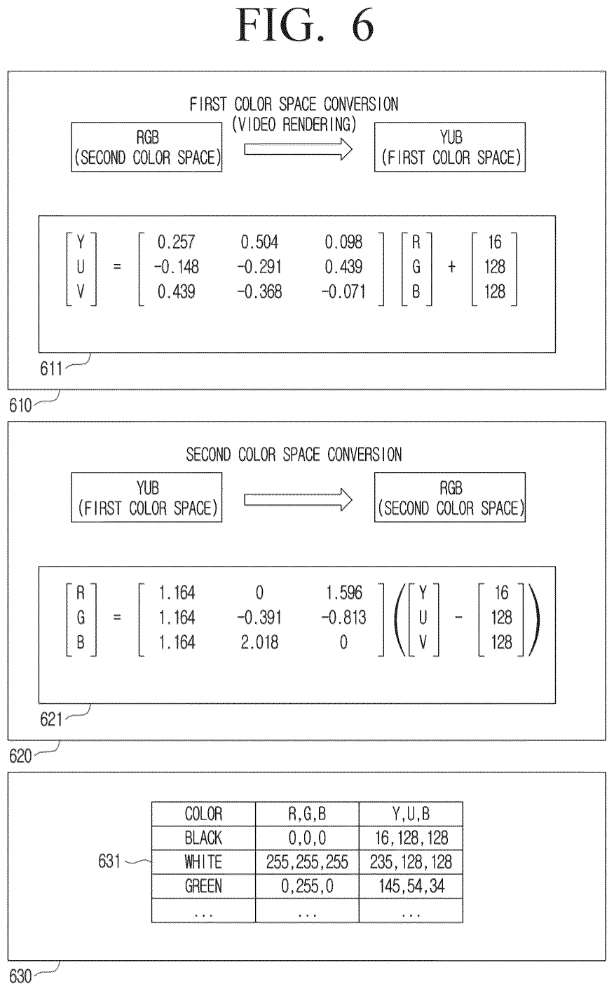

The first color space conversion may include an operation of converting the pixel information of the second color space into the pixel information of the first color space. A second color space conversion may include an operation of converting the pixel information of the first color space into the pixel information of the second color space. The first color space conversion and the second color space conversion are described with reference to FIG. 6.

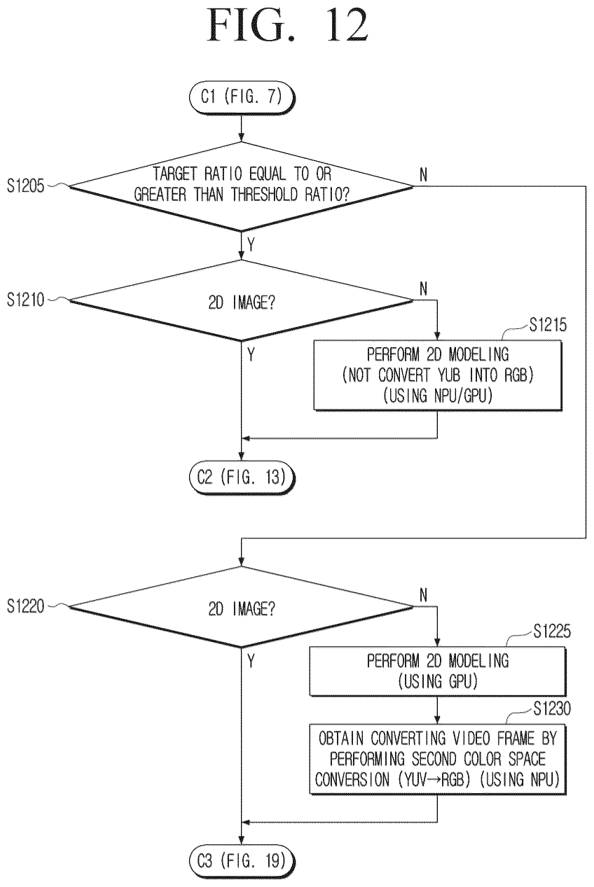

The at least one processor 120 may identify whether the video frame is a 2D image. Unless the video frame is a 2D image, the at least one processor 120 may perform 2D modeling on the video frame. Descriptions in relation to this are provided with reference to FIG. 12.

According to an embodiment, the first color space may be YUV or YUVA, and the second color space may be RGB or RGBA. Unless limited to the above limitations, the first color space and the second color may denote various color spaces. The color spaces may indicate CMYK (cyan, magenta, yellow, and key/black), HSV (hue, saturation, and value), and the like.

The electronic apparatus 100 may include a communication interface 130 connected to an extended reality (XR) device 200. The at least one processor 120 may transmit the final encoding data to the XR device 200 through the communication interface 130.

The XR device 200 may receive the final encoding data from the electronic apparatus 100. The XR device 200 may decode the final encoding data received. The XR device may output (or display) a screen including the video frame and the UI frame based on the decoded data.

According to an embodiment, the electronic apparatus 100 itself may decode the final encoding data. The electronic apparatus 100 may output (or display) the decoded data.

The electronic apparatus 100 may not output the video frame and the UI frame as one layer (or screen) in which the video frame and the UI frame are simply merged. The electronic apparatus 100 may obtain encoding data in consideration of the overlap portion of the video frame and the UI frame.

In the case where the color space of the video frame and the color space of the UI frame differ, quality may deteriorate or processing time may be lengthened during the merging process. In the case where a portion overlapping the UI frame in the video frame is separately coupled to the UI frame, final display quality may improve and an encoding processing speed may increase. The electronic apparatus 100 itself may control the display 140 to display a frame (or image).

In the above descriptions, the final encoding data is generated. According to an embodiment, the electronic apparatus 100 may receive a video frame and a UI frame, and directly couple and display the received video frame and UI frame. While the electronic apparatus 100 may perform operations in relation to the video frame and the UI frame in the same way, generate merging data rather than encoding data, and display the merged data. For a corresponding embodiment, the encoding data may be described as video data or partial data.

In one example, the electronic apparatus 100, in relation to the operation of FIG. 13, may obtain first video data by encoding the non-overlap video region in the operation of S1310. The electronic apparatus 100 may obtain second video data by encoding coupling data in the operation of S1350. The electronic apparatus 100 may obtain final video data by merging the first video data and the second video data in the operation of S1360. The electronic apparatus 100 may output (or display) the final video data through the display 140. An identical method (replacing the encoding data with the video data) in relation to this may be applied to various embodiments of the disclosure.

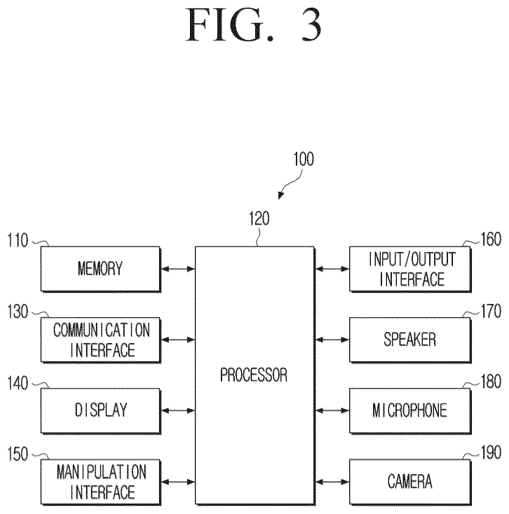

FIG. 3 is a block diagram provided to explain a detailed configuration of the electronic apparatus of FIG. 2, according to an embodiment.

Referring to FIG. 3, the electronic apparatus 100 may include at least one of memory 110, at least one processor 120, a communication interface 130, a display 140, a manipulation interface 150, an input/output interface 160, a speaker 170, a microphone 180 or a camera 190.

The memory 110 may be implemented as internal memory such as ROM (e.g., electrically erasable programmable read-only memory (EEPROM)), RAM, and the like included in the at least one processor 120, or may be implemented as memory separate from the at least one processor 120. The memory 110 may be implemented in the form of memory embedded in the electronic apparatus 100 or in the form of memory detachable from the electronic apparatus 100 depending on a data storage purpose. For example, in the case of data for driving the electronic apparatus 100, the data may be stored in the memory embedded in the electronic apparatus 100, and in the case of data for an expansion function of the electronic apparatus 100, the data may be stored in memory detachable from the electronic apparatus 100.

The memory embedded in the electronic apparatus 100 may be implemented in the form of at least one of volatile memory (e.g., dynamic RAM (DRAM), static RAM (SRAM) or synchronous dynamic RAM (SDRAM), or the like), or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, or solid state drive (SSD)), and the memory detachable from the electronic apparatus 100 may be implemented in the form of a memory card (e.g., a compact flash (CF), a secure digital (SD), a micro secure digital (Micro-SD), a mini secure digital (Mini-SD), an extreme digital (xD), a multi-media card (MMC), or the like), external memory connectable to a USB port (e.g., USB memory), or the like.

The memory 110 may store at least one instruction. Based on the instruction stored in the memory 110, the at least one processor 120 may perform a variety of operations.

The at least one processor 120 may be implemented as a digital signal processor (DSP) for processing digital signals, a microprocessor, or a time controller (TCON), but the at least one processor 120 may not be limited thereto, and may include one or more of a central processing unit (CPU), a micro controller unit (MCU), a micro processing unit (MPU), a controller, an application processor (AP), a graphics-processing unit (GPU) or a communication processor (CP), an advanced reduced instruction set computer (RISC) machines (ARM) processor, or may be defined as a corresponding term. The at least one processor 120 may be implemented in the form of a system on chip (SoC) with embedded processing algorithms, a large scale integration (LSI), or in the form of a field programmable gate array (FPGA). The at least one processor 120 may perform a variety of functions by executing computer executable instructions stored in the memory.

The communication interface 130 is an element that communicates with various types of external apparatuses, based on various types of communication methods. The communication interface 130 may include a wireless communication module or a wired communication module. Each communication module may be implemented in the form of at least one hardware chip.

The wireless communication module may be a module that communicates with an external apparatus wirelessly. For example, the wireless communication module may include at least one of a WiFi module, a Bluetooth module, an infrared communication module or other communication modules.

The WiFi module and the Bluetooth module may perform communication based on a WiFi method and a Bluetooth method respectively. In the case where the WiFi module or the Bluetooth module is used, various types of connection information such as a service set identifier (SSID), a session key and the like may be first transmitted and received, and are used to perform communication connection and then transmit and receive various types of information.

The infrared communication module performs communication based on an infrared Data Association (IrDA) communication technology which transmits data wirelessly over a short distance using infrared rays between optical light and millimeter waves.

In addition to the above-described communication methods, other communication modules may include at least one communication chip that performs communication according to various wireless communication standards such as Zigbee, 3rd Generation (3G), 3rd Generation Partnership Project (3GPP), Long Term Evolution (LTE), LTE Advanced (LTE-A), 4th Generation (4G), 5th Generation (5G) and the like.

A wired communication module may be a module that performs communication with an external apparatus via cable. For example, the wired communication module may include at least one of a local area network (LAN) module, an Ethernet module, pair cables, coaxial cables, fiber optic cables, or an Ultra Wide-Band (UWB) module.

According to an embodiment, the communication interface 130 may use an identical communication module (e.g., a WiFi module) to communicate with an external apparatus such as a remote control device and an external server.

According to an embodiment, the communication interface 130 may use a different communication module to communicate with an external apparatus such as a remote control device and an external server. For example, the communication interface 130 may use at least one of an Ethernet module or a WiFi module to communicate with an external server, and use a Bluetooth module to communicate with an external apparatus such as a remote control device. However, these are only provided as examples, and the communication interface 130 may use at least one communication module among various types of communication modules in the case where the communication interface 130 communicates with a plurality of external apparatuses or external servers.

The display 140 may be implemented as various types of displays such as a liquid crystal display (LCD), an organic light emitting diode (OLED) display, a plasma display panel (PDP) and the like. In the display 140, driving circuitry implemented in the form of an amorphous silicon thin film transistor (a-si TFT), a low temperature poly silicon (LTPS) TFT, an organic TFT (OTFT) and the like, a backlight unit and the like may be included together. The display 140 may be implemented as a touch screen coupled with a touch sensor, a flexible display, a three-dimensional (3D) display and the like. According to an embodiment, the display 140 may include a bezel housing a display panel as well as a display panel outputting an image. In particular, a bezel according to an embodiment may include a touch sensor for sensing a user interaction.

The manipulation interface 150 may be implemented as a device such as a button, a touch pad, a mouse and a keyboard, or implemented as a touch screen capable of performing the above-described display function and manipulation input function together. The button may be various types of buttons such as a mechanical button, a touch pad, a wheel and the like that are formed in any area such as the front, side, rear and the like of the exterior of the main body of the electronic apparatus 100.

The input/output interface 160 may be any one of a High-Definition Multimedia Interface (HDMI), a Mobile High-Definition Link (MHL), a Universal Serial Bus (USB), a Display Port (DP), a Thunderbolt, a Video Graphics Array (VGA) port, a RGB port, a D-subminiature (D-SUB), a Digital Visual Interface, (DVI). The input/output interface 160 may input/output at least one of an audio signal or a video signal. Depending on embodiments, the input/output interface 160 may include a port inputting/outputting an audio signal only and a port inputting/outputting a video signal only as an individual port, or be implemented as one port inputting/outputting both of an audio signal and a video signal. The electronic apparatus 100 may transmit, to an external apparatus (e.g., an external display device or an external speaker), at least one of audio signal or video signals through the input/output interface 160. An output port included in the input/output interface 160 may be connected with an external apparatus, and the electronic apparatus 100 may transmit at least one of audio signals or video signals to the external apparatus through the output port.

The input/output interface 160 may be connected with the communication interface. The input/output interface 160 may transmit information received from an external device to the communication interface or transmit information received through the communication interface to an external device.

The speaker 170 may be an element that outputs various types of notification sounds or voice messages and the like as well as various types of audio data.

The microphone 180 is an element for receiving a user voice or another sound and converting the same into audio data. The microphone 180 may receive a user voice in an activated state. For example, the microphone 180 may be integrally formed in the directions of the upper side or front surface, lateral surface and the like of the electronic apparatus 100. The microphone 180 may include various types of elements such as a microphone collecting a user voice in an analogue form, amp circuitry amplifying the user voice collected, an A/D conversion circuitry sampling the user voice amplified and converting the same into a digital signal, and filter circuitry removing a noise component from the digital signal converted, and the like.

The camera 190 is an element for capturing an image of an object and generating a captured image, and the captured image includes both a moving image and a still image. The camera 190 may obtain an image of at least one external device, and may be implemented as a camera, a lens, an infrared sensor and the like.

The camera 190 may include a lens and an image sensor. The sort of lenses may be categorized as a normal universal lens, a wide-angle lens, a zoom lens and the like, and may be determined depending on the sort, properties, usage environment and the like of an electronic apparatus 100. For the image sensor, a complementary metal oxide semiconductor (CMOS), a charge coupled device (CCD) and the like may be used.

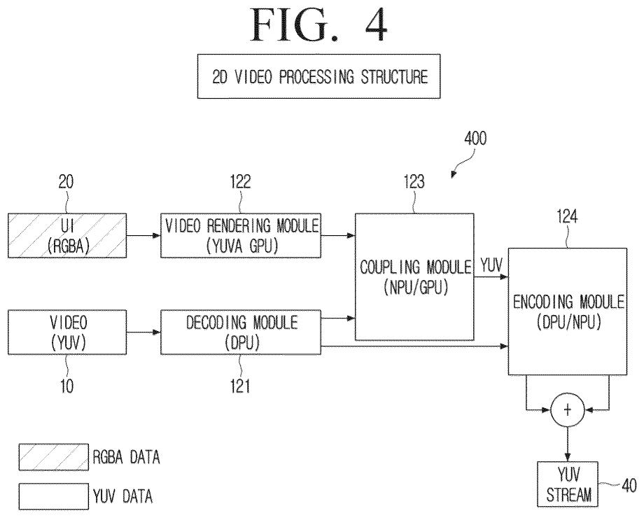

FIG. 4 is a view provided to explain a 2D video processing structure, according to an embodiment.

Referring to an embodiment 400 of FIG. 4, the electronic apparatus 100 may obtain a two-dimensional video frame 10. The electronic apparatus 100 may output a UI frame 20 together with the video frame 10.

The electronic apparatus 100 may include at least one of a decoding module 121, a video rendering module 122, a coupling module 123 and an encoding module 124. The decoding module 121, the video rendering module 122, the coupling module 123 or the encoding module 124 may be included in the at least one processor 120.

The decoding module 121 may be a module that performs a decoding operation on an input frame. The decoding module 121 may decode original data. The decoding module 121 may be a module that performs an operation of converting encoded (or encrypted or coded) information into original information.

In one example, the decoding module 121 may be included in a display processing unit (DPU). The DPU may be included in the at least one processor 120.

The electronic apparatus 100 may input the video frame 10 to the decoding module 121. The electronic apparatus 100 may obtain a video frame decoded through the decoding module 121.

The electronic apparatus 100 may identify at least one of a non-overlap video region or an overlap video region, in the video frame 10.

The electronic apparatus 100 may input the non-overlap video region to the encoding module 124. The electronic apparatus 100 may obtain first encoding data through the encoding module 124.

In one example, the encoding module 124 may be included in the DPU.

In one example, the encoding module 124 may be included in a neural processing unit (NPU). The NPU may be included in the at least one processor 120.

The electronic apparatus 100 may input the overlap video region to the coupling module 123.

The electronic apparatus 100 may input the UI frame 20 to the video rendering module 122. The electronic apparatus 100 may obtain a first rendering UI frame through the video rendering module 122.

The video rendering module 122 may perform a rendering operation of changing the pixel information of the second color space RGBA to the pixel information of the first color space YUV.

In one example, the video rendering module 122 may be included in a graphics processing unit (GPU). The GPU may be included in the at least one processor 120.

The electronic apparatus 100 may input the first rendering UI frame to the coupling module 123.

The coupling module 123 may be a module that couple (or composition) at least one frame (or data).

In one example, the coupling module 123 may be included in the GPU.

In one example, the coupling module 123 may be included in the NPU.

In one example, the coupling module 123 may be included in each of the GPU and NPU.

The electronic apparatus 100 may obtain coupling data by coupling the overlap video region and the first rendering UI frame received from the video rendering module 122.

The electronic apparatus 100 may input the coupling data to the encoding module 124.

The electronic apparatus 100 may obtain second encoding data through the encoding module 124.

The electronic apparatus 100 may obtain final encoding data 40 by merging the first encoding data and the second encoding data.

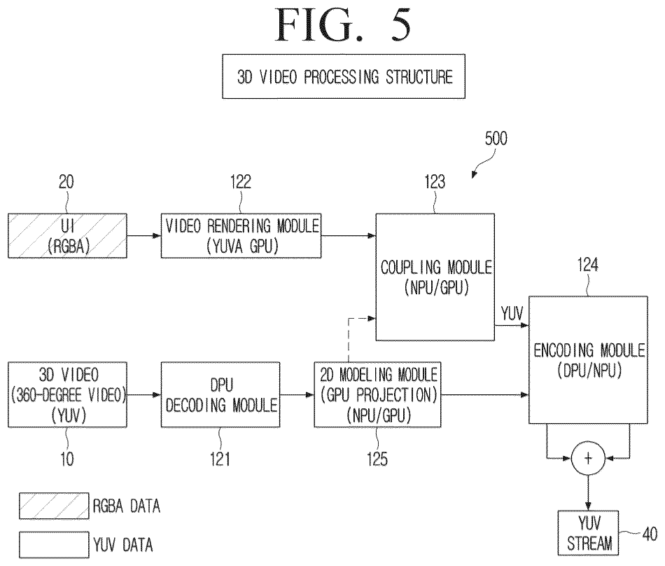

FIG. 5 is a view provided to explain a 3D video processing structure, according to an embodiment.

Referring to an embodiment 500 of FIG. 5, the electronic apparatus 100 may obtain a three-dimensional video frame 10. The 3D video frame 10 may be a 360-degree video frame. In one example, the 3D video frame 10 may be an XR frame that is provided to an extended reality (XR) device. The electronic apparatus 100 may output a UI frame 20 together with the video frame 10.

The decoding module 121, video rendering module 122, coupling module 123 and encoding module 124 of FIG. 5 are described with reference to FIG. 4. Repetitive description is avoided.

The electronic apparatus 100 may include at least one of a decoding module 121, a video rendering module 122, a coupling module 123, an encoding module 124 or a 2D modeling module 125.

The 2D modeling module 125 may be a module that converts a three-dimensional video frame into a two-dimensional video frame. The electronic apparatus 100 may input a decoded video frame (3D) received from the decoding module 121 to the 2D modeling module 125.

In one example, the 2D modeling module 125 may be included in the GPU.

In one example, the 2D modeling module 125 be included in the NPU.

The electronic apparatus 100 may obtain a two-dimensional decoded video frame through the 2D modeling module 125. The electronic apparatus 100 may identify at least one of a non-overlap video region or an overlap video region, in the two-dimensional decoded video frame.

The electronic apparatus 100 may transmit the overlap video region to the coupling module 123. The electronic apparatus 100 may transmit the non-overlap video region to the encoding module 124. The other operations may correspond to those of FIG. 4. Repetitive description is avoided.

FIG. 6 is a view provided to explain a color space conversion operation, according to an embodiment.

Referring to an embodiment 610 of FIG. 6, the electronic apparatus 100 may convert pixel information from the second color space (RGB) to the first color space (YUV) by performing a first color space conversion. The first color space conversion may include an operation of converting pixel information of the second color space (RGB) to pixel information of the first color space (YUV).

The electronic apparatus 100 may perform the first color space conversion by using first function information 611. The electronic apparatus 100 may convert the second color space (RGB) to the first color space (YUV) by using the first function information 611.

The electronic apparatus 100 may perform video rendering. The video rendering may include an operation of converting the second color space (RGB) to the first color space (YUV) by using the first function information 611.

The operation of converting the second color space (RGB) to the first color space (YUV) by using the first function information 611 may be described as video rendering.

Referring to an embodiment 620 of FIG. 6, the electronic apparatus 100 may convert pixel information from the first color space (YUV) to the second color space (RGB) by performing a second color space conversion. The second color space conversion may include an operation of converting pixel information of the first color space (YUV) into pixel information of the second color space (RGB).

The electronic apparatus 100 may perform the second color space conversion by using second function information 621. The electronic apparatus 100 may convert the first color space (YUV) into the second color space (RGB) by using the second function information 621.

Referring to an embodiment 630 of FIG. 6, the electronic apparatus 100 may perform the first color space conversion or the second color space conversion based on a color space lookup table 631. The color space lookup table 631 may include predetermined mapping information. The mapping information may include information in which an RGB value corresponding to a specific YUV value is mapped.

In one example, pixel information of the first color space (YUV) indicating black may be 0, 0 and 0, and pixel information of the second color space (RGB) indicating black may be 16, 128 and 128. The color space lookup table 631 may include information in which YUV (16, 128 and 128) and RGB (0, 0 and 0) are mapped.

In one example, in the case where a pixel value in the second color space (RGB) is 0≤R,G,B≤255, a pixel value in the first color space (YUV) may be 16≤Y≤235 and/or 16≤U,V≤240.

In one example, in the case where a window buffer is divided into a block unit, rapid parallel processing may be possible by using the NPU.

In one example, the color space lookup table 631 may include information in which YUV and RGB are mapped.

In one example, the color space lookup table 631 may include information in which YUV and RGBA are mapped.

In one example, the color space lookup table 631 may include information in which YUVA and RGB are mapped.

In one example, the color space lookup table 631 may include information in which YUVA and RGBA are mapped.

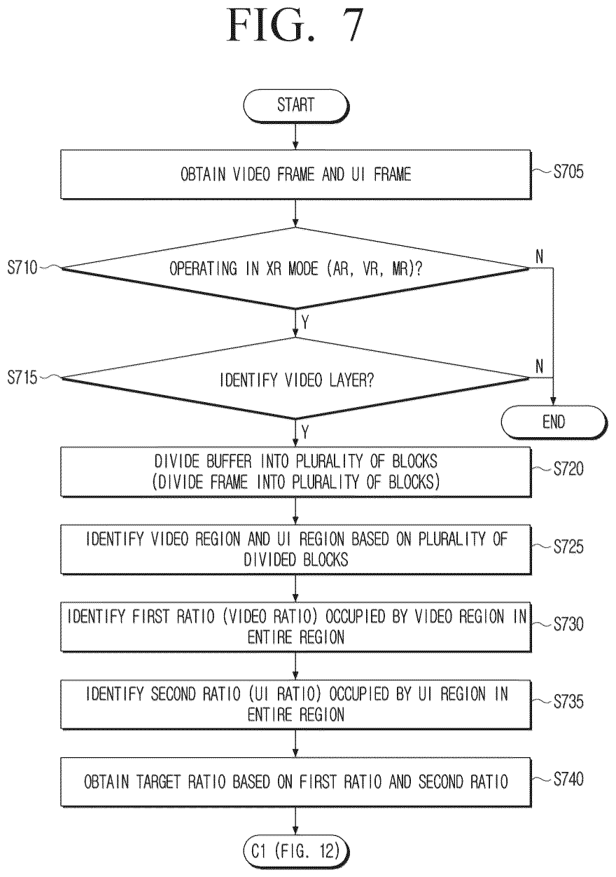

FIG. 7 is a view provided to explain an operation of obtaining a target ratio by identifying a video region and a UI region and, according to an embodiment.

Referring to FIG. 7, the electronic apparatus 100 may obtain a video frame 10 and a UI frame 20. The electronic apparatus 100 may receive a control instruction for outputting the video frame 10 and the UI frame 20 together.

In one example, the video frame 10 may be an extended reality (XR) frame. The XR frame may include a virtual reality (VR) frame, an augmented reality (AR) frame or a mixed reality (MR) frame.

The electronic apparatus 100 may identify whether a device (e.g., an XR device) outputting a frame is operating in an XR mode (S710). The XR mode may include a VR mode, an AR mode or an MR mode. In the case of an operation in the XR mode (S710-Y), the electronic apparatus 100 may determine whether a video layer is identified.

The electronic apparatus 100 may perform video processing to display the video frame 10. The video processing may include an operation of displaying a video layer. The electronic apparatus 100 may determine whether the video layer is identified. The electronic apparatus 100 may generate the video layer based on the video frame 10. The electronic apparatus 100 may determine whether the video layer is generated (or displayed).

According to an embodiment, S710 and/or S715 may be omitted.

According to an embodiment, S710 may be replaced with an operation of determining whether the electronic apparatus 100 is operating in an external display mode. The external display mode may denote a mode in which a frame (or sub frame) is output to an additional display device in addition to the XR device outputting a frame.

In the case where the video layer is identified (S715-Y), the electronic apparatus 100 may divide the buffer into a plurality of blocks. The electronic apparatus 100 may divide a window buffer or a frame buffer into a plurality of blocks. The plurality of blocks may be a predetermined number of blocks.

The window buffer may be a memory space storing pixel information on a specific region of a screen.

The frame buffer may be a memory space storing pixel information on the entire region of a screen.

The electronic apparatus 100 may encode the blocks stored in the window buffer and the frame buffer. The electronic apparatus 100 may perform an encoding operation through the encoding module 124.

The electronic apparatus 100 may identify the video region and the UI region based on a plurality of divided blocks (S725). The electronic apparatus 100 may identify the video region in which the video frame 10 is displayed from an entire screen where the frame is displayed. The electronic apparatus 100 may identify the UI region in which the UI frame 20 is displayed from the entire screen.

The electronic apparatus 100 may identify a first ratio (or video ratio) occupied by the video region, in the entire region indicating the entire screen (S730).

The electronic apparatus 100 may identify a second ratio (or UI ratio) occupied by the UI region, in the entire region indicating the entire screen (S735).

The electronic apparatus 100 may obtain a target ratio based on the first ratio and the second ratio (S740). The target ratio may be a value based on dividing the first ratio by the second ratio. The target ratio may denote a relationship of the ratio occupied by the video region or the UI region, in the entire region. The target ratio may indicate which of the video region and the UI region occupies a greater region, in the entire region.

In the case where the target ratio is obtained, the electronic apparatus 100 may perform operations disclosed in FIG. 12.

According to an embodiment, the electronic apparatus 100 may not calculate the target ratio. The electronic apparatus 100 may compare the first ratio and the second ratio. The electronic apparatus 100 may determine whether which of the first ratio or the second ratio is greater.

FIG. 8 is a view provided to explain an operation of dividing a window buffer and a frame buffer, according to an embodiment.

Referring to an embodiment 810 of FIG. 8, the electronic apparatus 100 may divide the window buffer into a predetermined number of buffers. The widow buffer may denote a buffer for displaying at least one of the video region or the UI region.

Referring to an embodiment 820 of FIG. 8, the electronic apparatus 100 may divide the frame buffer into a predetermined number of buffers. The frame buffer may denote a buffer for displaying the entire region.

In the embodiments 810, 820 of FIG. 8, the size of the window buffer and the size of the frame buffer may be identical. In the case where the video frame 10 is displayed on the entire screen, the size of the window buffer and the size of the frame buffer may be identical.

The electronic apparatus 100 may divide a plurality of blocks by using the window buffer or the frame buffer. The electronic apparatus 100 may identify the video region and the UI region by using the plurality of divided blocks.

FIG. 9 is a view provided to explain an operation of identifying a video region and a UI region, according to an embodiment.

Referring to an embodiment 910 of FIG. 9, a video region 911 may be greater than a UI region 912 on a screen 901. The size of the video frame 10 displayed may be greater the size of the UI frame 20 displayed. The video region 911 may be an entire region of 16 blocks, in an entire region of a total of 16 blocks. The UI region 912 may be a region including four middle blocks.

Referring to an embodiment 920 of FIG. 9, a UI region 922 may be greater than a video region 921 on a screen 902. The size of the UI frame 20 displayed may be greater the size of the video frame 10 displayed. The video region 921 may be a region of eight lower blocks (all the third and fourth rows). The UI region 922 may be a region of 12 blocks (all the first, second and third rows).

FIG. 10 is a view provided to explain a frame in which a video region occupies a greater ratio than a UI region, according to an embodiment.

FIG. 10 may correspond to the embodiment 910 of FIG. 9. The electronic apparatus 100 may identify a video region 1011 and a UI region 1012, on an entire screen 1001.

Referring to a table 1020 of FIG. 10, the electronic apparatus 100 may calculate a target ratio in relation to the screen 1001.

The electronic apparatus 100 may identify the number of blocks (e.g., 16 blocks) in the entire region. The electronic apparatus 100 may identify the number (e.g., 16) of blocks occupied by the video region 1011 from the number of blocks in the entire region. The electronic apparatus 100 may identify the number (e.g., 4) of blocks occupied by the UI region 1012 from the number of blocks in the entire region.

The electronic apparatus 100 may identify a first ratio (e.g., 1) occupied by the number of blocks occupied by the video region 1011, from the number of entire blocks. The first ratio may be described as a video ratio or r_YUV.

The electronic apparatus 100 may identify a second ratio (e.g., 0.25) occupied by the number of blocks occupied by the UI region 1012, from the number of the entire blocks. The second ratio may be described as a UI ratio or r_RGB.

The electronic apparatus 100 may obtain a target ratio based on the first ratio and the second ratio. The target ratio may be a value (e.g., 4) based on dividing the first ratio by the second ratio. The target ratio may be described as r_total.

In the case where the target ratio is greater than 1, the electronic apparatus 100 may identify that the video region 1011 is greater than the UI region 1012.

In the case where the target ratio is 1, the electronic apparatus 100 may identify that the size of the video region 1011 is identical with the size of the UI region 1012.

In the case where the target ratio is less than 1, the electronic apparatus 100 may identify that the video region 1011 is less than the UI region 1012.

Since the target ratio is equal to or greater than 1, the electronic apparatus 100 may identify that the video region 1011 is greater than the UI region 1012.

As a value of the target ratio becomes greater than 1, the electronic apparatus 100 may identify that the video region 1011 is relatively large.

As the value of the target ratio becomes closer to 0, the electronic apparatus 100 may identify that the UI region 1012 is relatively large.

FIG. 11 is a view provided to explain a frame in which a UI region occupies a greater ratio than a video region, according to an embodiment.

FIG. 11 may correspond to the embodiment 920 of FIG. 9. The electronic apparatus 100 may identify a video region 1111 and a UI region 1112, on the entire screen 1001.

Referring to a table 1120 of FIG. 11, the electronic apparatus 100 may calculate a target ratio in relation to the screen 1001.

The electronic apparatus 100 may identify the number (e.g., 16) of blocks in the entire region. The electronic apparatus 100 may identify the number (e.g. 8) of blocks occupied by the video region 1111, from the number of blocks of the entire region. The electronic apparatus 100 may identify the number (e.g., 12) of blocks occupied by the UI region 1112, from the number of blocks of the entire region.

The electronic apparatus 100 may identify a first ratio (e.g., 0.5) occupied by the number of blocks occupied by the video region 1111, from the number of entire blocks. The first ratio may be described as a video ratio or r_YUV.

The electronic apparatus 100 may identify a second ratio (e.g., 0.75) occupied by the number of blocks occupied by the UI region 1112, from the number of the entire blocks. The second ratio may be described as a UI ratio or r_RGB.

The electronic apparatus 100 may obtain a target ratio based on the first ratio and the second ratio. The target ratio may be a value (e.g., 0.67) based on dividing the first ratio by the second ratio. The target ratio may be described as r_total.

Descriptions in relation to the target ratio are provided with reference to FIG. 10. Repetitive description is avoided. Since the target ratio is less than 1, the electronic apparatus 100 may identify that the UI region 1012 is greater than the video region 1011.

FIG. 12 is a view provided to explain an operation of performing a different operation based on a target ratio, according to an embodiment.

In the case where the target ratio is obtained according to the embodiment of FIG. 7, the electronic apparatus 100 may identify whether the target ratio is equal to or greater than a threshold ratio (S1205). The threshold ratio may be a predetermined ratio. The threshold ratio may be changed depending on user settings.

The threshold ratio may be a criterion for determining whether the video region is a main region, on the entire scree, by the electronic apparatus 100.

In the case where the target ratio is equal to or greater than the threshold ratio, the electronic apparatus 100 may couple a non-overlap video region and a UI frame based on the first color space (YUV). An operation in relation to this is described in detail with reference to FIGS. 13-15.

In the case where the target ratio is equal to or greater than the threshold ratio (S1205-Y), the electronic apparatus 100 may identify whether a video frame 10 is a 2D image (S1210). The electronic apparatus 100 may identify whether the video frame 10 is a 2D image based on the dimension of pixel information included in the video frame 10.

In the case where the video frame 10 is a 2D image (S1210-Y), the electronic apparatus 100 may perform operations disclosed in FIG. 13.

Unless the video frame 10 is a 2D image (S1210-N), the electronic apparatus 100 may perform 2D modeling (S1215). The 2D modeling may be performed by the 2D modeling module 125 of FIG. 5. The 2D modeling may not include an operation of converting from the first color space (YUV) into the second color space (RGB). The 2D modeling may include an operation of converting a three-dimensional frame or a three-dimensional image into a two-dimensional frame or a two-dimensional image.

When performing the 2D modeling, the electronic apparatus 100 may use an NPU or a GPU. The electronic apparatus 100 may perform the 2D modeling by selecting a processing unit having the greatest processing speed. This is to reduce processing time taken to perform the 2D modeling.

The electronic apparatus 100 may obtain at least one of frequencies of the GPU, workload of the GPU, frequencies of the NPU or workload of the NPU. The electronic apparatus 100 may select a processing unit to perform the 2D modeling operation, based on at least one of the frequencies of the GPU, the workload of the GPU, the frequencies of the NPU or the workload of the NPU.

In the case where the target ratio is less than the threshold ratio, the electronic apparatus 100 may couple the non-overlap video region and the UI frame based on the second color space (RGB). An operation in relation to this is described in detail with reference to FIGS. 19 and 20.

Unless the target ratio is equal to or greater than the threshold ratio (S1205-N), the electronic apparatus 100 may identify whether the video frame 10 is a 2D image (S1210). The electronic apparatus 100 may identify whether the video frame 10 is a 2D image based on the dimension of pixel information included in the video frame 10.

In the case where the video frame 10 is a 2D image (S1220-Y), the electronic apparatus 100 may perform operations disclosed in FIG. 19.

Unless the video frame 10 is a 2D image (S1220-N), the electronic apparatus 100 may perform 2D modeling (S1225). The electronic apparatus 100 may perform the 2D modeling by using the GPU.

The electronic apparatus 100 may obtain a converting video frame by performing a second color space conversion on the video frame 10 (S1230). The electronic apparatus 100 may obtain a video frame converted from the first color space (YUV) into the second color space (RGB). The electronic apparatus 100 may perform the second color space conversion by using the NPU.

In S1215, the processing unit to perform 2D modeling is selected based on at least one of the frequencies of the GPU, the workload of the GPU, the frequencies of the NPU or the workload of the NPU.

In S1225, 2D modeling may be performed in the GPU. In the case where the UI region outweighs the video region, the importance of a processing speed may be relatively low. The electronic apparatus 100 may use the GPU fixedly when performing the 2D modeling to secure high (or reliable) quality. The electronic apparatus 100 may perform the 2D modeling by using the GPU, and perform the second color space conversion by using the NPU to obtain a converting video frame.

The electronic apparatus 100 may perform operations disclosed in FIG. 19 based on the converting video frame.

The electronic apparatus 100 may convert a three-dimensional video frame 10 into a two-dimensional video frame. Based on the converted video frame, the electronic apparatus 100 may perform the operations disclosed in FIG. 13.

FIG. 13 is a view provided to explain an operation of obtaining final encoding data in a case where a target ratio is equal to or greater than a threshold ratio, according to an embodiment. The operations in FIG. 13 may be performed after S1210 or S1215 of FIG. 12 is performed.

Referring to FIG. 13, the electronic apparatus 100 may identify a non-overlap video region that does not overlap the UI region in the video region, and an overlap video region that overlaps the UI region in the video region (S1305).

The electronic apparatus 100 may obtain first encoding data by encoding the non-overlap video region (S1310). The electronic apparatus 100 may store the non-overlap video region by using the window buffer. The electronic apparatus 100 may store the first encoding data in the frame buffer. The electronic apparatus 100 may obtain the first encoding data by using the encoding module 124 of FIG. 4. The first encoding data may include pixel information of the first color space.

The electronic apparatus 100 may identify whether video rendering is possible (S1315). The electronic apparatus 100 may identify whether a video rendering function is performable.

The video rendering may include an operation of converting a frame of the second color space (RGB) to a frame of the first color space (YUV). The video rendering may include an operation of converting the second color space (RGB) into the first color space (YUV) by using first function information 611. The video rendering may be described as YUV/YUVA rendering.

The electronic apparatus 100 may store a list of functions performable by the electronic apparatus 100 in the memory 110. The electronic apparatus 100 may identify whether a video rendering function is included in the stored list of functions.

In the case where the rendering function is included in the list of functions, the electronic apparatus 100 may identify that the video rendering is performable.

In the case where it is identified that the video rendering is performable (S1315-Y), the electronic apparatus 100 may obtain a first rendering UI frame by performing the video rendering on the UI frame 20 (S1320). The first rendering UI frame may include the pixel information of the first color space. The first rendering UI frame may include the pixel information of YUV/YUVA.

The electronic apparatus 100 may obtain coupling data by coupling (composition) the overlap video region and the first rendering UI frame (S1325). The electronic apparatus 100 may perform a coupling operation based on the first color space. The electronic apparatus 100 may obtain coupling data of the first color space by coupling the first rendering UI frame of the first color space and the overlap video region of the first color space.

In one example, the first color space may be YUV. The electronic apparatus 100 may perform a YUV coupling operation.

In one example, the electronic apparatus 100 may use the NPU when performing the coupling operation in operation 1325.

In one example, the electronic apparatus 100 may use the GPU when performing the coupling operation in operation 1325.

In the case where it is not identified that the video rendering is possible (S1315-N), the electronic apparatus 100 may obtain a second rendering UI frame by performing UI rendering on the UI frame 20 (S1330). The electronic apparatus 100 may obtain a second rendering UI frame of the second color space.

The UI rendering may denote applying a predetermined rendering function to the UI frame. The UI rendering may include an operation of applying the predetermined rendering function based on the second color space. The predetermined rendering function may include at least one of a function of changing resolution, a function of changing a color space, a function of changing a position, or a function of changing style (font, color, size and the like) information.

In one example, the UI rendering may include a preprocessing operation required for a coupling operation.

In one example, the UI rendering may be RGB/RGBA rendering. The electronic apparatus 100 may obtain a second rendering UI frame of RGB/RGBA by performing the UI rendering on the UI frame 20.

The electronic apparatus 100 may obtain a converting UI frame by performing a first color space conversion on the second rendering UI frame (S1335). The electronic apparatus 100 may convert a second rendering UI frame of a second color space to a converting UI frame of a first color space by performing the first color space conversion.

In one example, the first color space may be YUV/YUVA, and the second color space may be RGB/RGBA.

In one example, the electronic apparatus 100 may perform the first color space conversion by using a color space lookup table 631.

In one example, the electronic apparatus 100 may perform the first color space conversion by using the first function information 611.

In one example, the electronic apparatus 100 may perform the first color space conversion by using the NPU.

In one example, the electronic apparatus 100 may perform the first color space conversion by using the first function information 611 through the NPU. The electronic apparatus 100 may generate the color space lookup table 631 as a result of performing the first color space conversion. The color space lookup table 631 may be updated based on a result of performing a new first color space conversion. The color space lookup table 631 may be used for the first color space conversion.

The electronic apparatus 100 may obtain coupling data by coupling (composition) the overlap video region and the converting UI frame (S1340). The electronic apparatus 100 may perform the coupling operation based on the first color space. The electronic apparatus 100 may obtain coupling data of the first color space by coupling the converting UI fame of the first color space and the overlap video region of the first color space.

In one example, the first color space may be YUV. The electronic apparatus 100 may perform a YUV coupling operation.

In one example, the electronic apparatus 100 may use an NPU when performing the coupling operation in S1340.

In one example, the electronic apparatus 100 may use a GPU when performing the coupling operation in operation S1340.

The electronic apparatus 100 may obtain second encoding data by encoding the coupling data obtained in S1325 or S1340 (S1350). The second encoding data may include pixel information of the first color space.

The electronic apparatus 100 may obtain final encoding data by merging the first encoding data and the second encoding data (S1360). The final encoding data may include the pixel information of the first color space.

FIG. 14 is a view provided to explain an operation of obtaining final encoding data in a case where video rendering is possible, according to an embodiment.

FIG. 14 may illustrate an embodiment of obtaining final encoding data in the case where the video rendering function determined in S1315 of FIG. 13 is performable.

The electronic apparatus 100 may obtain a video frame 1410 and a UI frame 1420. The electronic apparatus 100 may receive a control instruction for outputting the video frame 1410 and the UI frame 1420 together.

The electronic apparatus 100 may identify a non-overlap video region 1411 that does not overlap the UI frame 1420, with respect to the video frame 1410.

The electronic apparatus 100 may identify an overlap video region 1412 that overlaps the UI frame 1420, with respect to the video frame 1410.

The electronic apparatus 100 may obtain first encoding data 1413 by encoding the non-overlap video region 1411.

The electronic apparatus 100 may obtain a first rendering UI frame 1421 by performing video rendering on the UI frame 1420. The video rendering may include a first color space conversion operation of converting pixel information of a second color space into pixel information of the first color space. The video rendering may include an operation of changing the UI frame 1420 for a coupling operation.

The electronic apparatus 100 may obtain coupling data 1430 by coupling the overlap video region 1412 ad the first rendering UI frame 1421. The electronic apparatus 100 may perform the coupling operation based on the first color space. In one example, the coupling operation may be described as YUV coupling (YUB composition).

The electronic apparatus 100 may obtain second encoding data 1431 by encoding the coupling data 1430.

The electronic apparatus 100 may obtain final encoding data 1440 by merging the first encoding data 1413 and the second encoding data 1431.

In one example, the video frame 1410, the non-overlap video region 1411, the overlap video region 1412, the first encoding data 1413, the first rendering UI frame 1421, the coupling data 1430, the second encoding data 1431 and the final encoding data 1440 may correspond to the first color space. Corresponding to the first color space may denote defining pixel information based on the first color space.

In one example, the UI frame 1420 may correspond to the second color space. Corresponding to the second color space may denote defining pixel information based on the second color space.

In one example, the first color space may be YUV, and the second color space may be RGB.

In one example, the first color space may be YUVA, and the second color space may be RGBA.

In one example, the first color space may be YUV, and the second color space may be RGBA.

In one example, the first color space may be YUVA, and the second color space may be RGB.

FIG. 15 is a view provided to explain an operation of obtaining final encoding data in a case where video rendering is impossible, according to an embodiment.

FIG. 15 illustrates an embodiment of obtaining final encoding data in the case where the video rendering function determined in S1315 of FIG. 13 is not performable.

The electronic apparatus 100 may obtain a video frame 1510 and a UI frame 1520. The electronic apparatus 100 may receive a control instruction for outputting the video frame 1510 and the UI frame 1520 together.

The electronic apparatus 100 may identify a non-overlap video region 1511 that does not overlap the UI frame 1520 with respect to the video frame 1510.

The electronic apparatus 100 may identify an overlap video region 1512 that overlaps the UI frame 1520 with respect to the video frame 1510.

The electronic apparatus 100 may obtain first encoding data 1513 by encoding the non-overlap video region 1511.

The electronic apparatus 100 may obtain second rendering UI frame 1521 by performing UI rendering on the UI frame 1520. The UI rendering may include an operation of changing the UI frame 1520 for a coupling operation.

The electronic apparatus 100 may obtain a converting UI frame 1522 by performing a first color space conversion on the second rendering UI frame 1521. The electronic apparatus 100 may convert pixel information of a second color space to pixel information of a first color space based on a color space lookup table 631.

The electronic apparatus 100 may obtain coupling data 1530 by coupling the overlap video region 1512 and the converting UI frame 1522. The electronic apparatus 100 may perform a coupling operation based on the first color space. In one example, the coupling operation may be described as YUV coupling (YUV composition).

The electronic apparatus 100 may obtain second encoding data 1531 by encoding the coupling data 1530.

The electronic apparatus 100 may obtain final encoding data 1540 by merging the first encoding data 1513 and the second encoding data 1531.

In one example, the video frame 1510, the non-overlap video region 1511, the overlap video region 1512, the first encoding data 1513, the converting UI frame 1522, the coupling data 1530, the second encoding data 1531, and the final encoding data 1540 may correspond to the first color space. Corresponding to the first color space may denote defining pixel information based on the first color space.

In one example, the UI frame 1520 and the second rendering UI frame 1521 may correspond to the second color space. Corresponding to the second color space may denote defining pixel information based on the second color space.

In one example, the first color space may be YUV, and the second color space may be RGB.

In one example, the first color space may be YUV, and the second color space may be RGBA.

In one example, the first color space may be YUVA, and the second color space may be RGBA.

In one example, the first color space may be YUVA, and the second color space may be RGB.

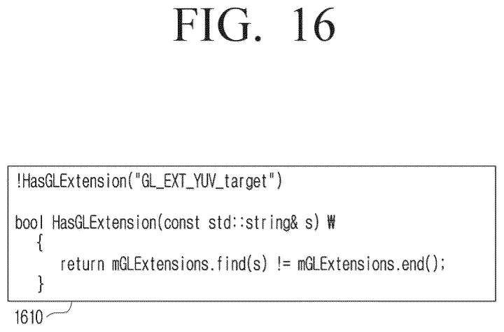

FIG. 16 is a view provided to explain an operation of determining whether video rendering is possible, according to an embodiment.

Referring to FIG. 16, the electronic apparatus 100 may determine whether video rendering is performable by the electronic apparatus 100 based on code information 1610.

The code information 1610 may include a code for identifying whether a video rendering function is included in a library used in an application for rendering an image.

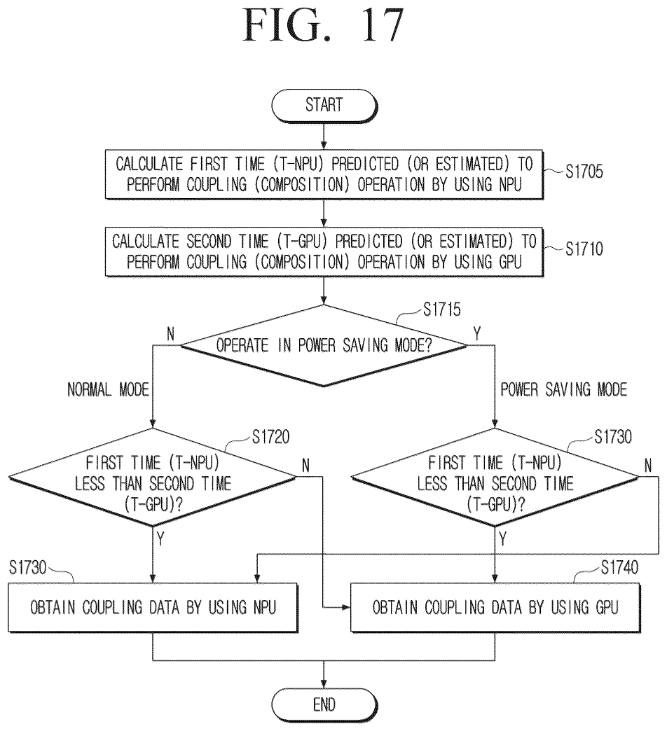

FIG. 17 is a view provided to explain an operation of determining a processing unit performing a coupling operation, according to an embodiment.

FIG. 17 may include an operation of determining a processing unit that performs the coupling operation described in S1325 of FIG. 13, S1340 of FIG. 13 or S1925 of FIG. 19.

The electronic apparatus 100 may select one processing unit of the NPU or GPU. The electronic apparatus 100 may perform the coupling operation (S1325, S1340 and S1925) by using the selected processing unit.

The electronic apparatus 100 may calculate (or obtain) first time T_NPU predicted (or estimated) to perform the coupling operation by using the NPU (S1705).

The electronic apparatus 100 may calculate (or obtain) second time T_GPU predicted (or estimated) to perform the coupling operation by using the GPU (S1710).

The electronic apparatus 100 may operate in a normal mode or a power saving mode.

The normal mode may be described as a performance mode. The power saving mode may be described as a low power mode. The term mode may be replaced with a state.

The electronic apparatus 100 may identify whether the electronic apparatus 100 is operating in the power saving mode (S1715).

In the case where the electronic apparatus 100 is not operating in the power saving mode (S1715-N), the electronic apparatus 100 may identify whether the first time T_NPU is less than the second time T_GPU (S1720).

In the case where the first time T_NPU is less than the second time T_GPU (S1720-Y), the electronic apparatus 100 may perform a coupling operation by using the NPU (S1730).

Unless the first time T_NPU is less than the second time T_GPU (S1720-Y), the electronic apparatus 100 may perform a coupling operation by using the GPU (S1740).

In the case where the electronic apparatus 100 is operating in the power saving mode (S1715-Y), the electronic apparatus 100 may identify whether the first time T_NPU is less than the second time T_GPU (S1730).

In the case where the electronic apparatus 100 operates in the normal mode, a processing speed may be important to the user. The electronic apparatus 100 may compare time (first time and second time) predicted for a coupling operation and select a processing unit enabling faster processing.

In the case where the first time T_NPU is less than the second time T_GPU (S1730-Y), the electronic apparatus 100 may perform a coupling operation by using the GPU (S1740).

Unless the first time T_NPU is less than the second time T_GPU (S1730-Y), the electronic apparatus 100 may perform a coupling operation by using the NPU (S1730).

In the case where the electronic apparatus 100 operates in the power saving mode, to the user, the quality of coupling data may be more important than a processing speed. Although the first time T_NPU is less than the second time T_GPU, the electronic apparatus 100 may select the GPU rather than the NPU.

According to an embodiment, in the case where the electronic apparatus 100 operates in the power saving mode, the electronic apparatus 100 may not perform S1730. In the case where the electronic apparatus 100 operates in the power saving mode, the electronic apparatus 100 may obtain coupling data by using the NPU (S1730). In the power saving mode, low power may be supplied. Accordingly, a processing unit ensuring minimum power consumption may be selected to perform the coupling operation. The NPU may be better than the GPU to reduce power consumption.

According to an embodiment, in the case where the NPU consumes more power than the GPU, the electronic apparatus 100 may perform the coupling operation in the power saving mode, by using the GPU.

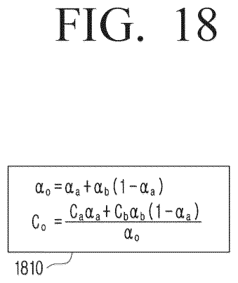

FIG. 18 is a view provided to explain an operation of processing an alpha value in a coupling operation, according to an embodiment.

Referring to FIG. 18, the electronic apparatus 100 may perform a coupling operation by using a math equation 1810.

The coupling data 1430 may include pixel information of a first color space (YUV). The coupling data 1430 may not include an alpha value. The alpha value may be a value indicating transparency. Information on transparency may be reflected to the first color space (YUV). The electronic apparatus 100 may reflect the alpha value to the pixel information by using the math equation 1810.

According to an embodiment, the electronic apparatus 100 may generate the coupling data 1430 of FIG. 14 by using the math equation 1810.
α_0 may be an alpha value of the coupling data 1430.
α_a may be an alpha value of the overlap video region 1412.
α_b may be an alpha value of coupling first rendering UI frame 1421.
C_0 may be a color configuration (or pixel information) of the coupling data 1430.
α_a may be a color configuration (or pixel information) of the overlap video region 1412.
α_b may be a color configuration (or pixel information) of coupling first rendering UI frame 1421.

The above descriptions may be applied to the coupling data generating operation in FIG. 15 and FIG. 20. Repetitive description is omitted.

FIG. 19 is a view provided to explain an operation of obtaining final encoding data in a case where a target ratio is less than a threshold ratio, according to an embodiment.

FIG. 19 is a view provided to explain the operation of obtaining the final encoding data in the case where the target ratio is less than the threshold ratio, according to an embodiment. The operations of FIG. 19 may be performed after S1220 or S1230 of FIG. 12 is performed.

Referring to FIG. 19, the electronic apparatus 100 may identify a non-overlap video region that does not overlap a UI region in the video region, and identify an overlap video region that overlaps the UI region in the video region (S1905).

The electronic apparatus 100 may obtain third encoding data by encoding the non-overlap video region (S1910). The electronic apparatus 100 may store the non-overlap video region by using a window buffer. The electronic apparatus 100 may store the third encoding data in a frame buffer. The electronic apparatus 100 may obtain the third encoding data by using the encoding module 124 of FIG. 4. The third encoding data may include pixel information of a first color space.

The electronic apparatus 100 may obtain a converting video region by performing a second color space conversion on the overlap video region (S1915). The second color space conversion may be an operation of converting the first color space to the second color space. The second color space conversion may include an operation of converting pixel information of the first color space to pixel information of the second color space. The electronic apparatus 100 may perform the second color space conversion by using a color space lookup table 631.

The electronic apparatus 100 may obtain a third rendering UI frame by performing UI rendering on a UI frame 20 (S1920). Descriptions in relation to the UI rendering are provided with reference to FIG. 13. Repetitive description is avoided.

The electronic apparatus 100 may obtain coupling data by coupling the converting video region and the third rendering UI frame (S1925).

The electronic apparatus 100 may perform the coupling operation based on the second color space. The electronic apparatus 100 may obtain coupling data of the second color space by coupling a third rendering UI frame of the second color space and a converting video region of the second color space.

In one example, the first color space may be RGB or RGBA. The electronic apparatus 100 may perform an RGB or RGBA coupling operation.

In one example, the electronic apparatus 100 may use an NPU when performing the coupling operation of S1925.

In one example, the electronic apparatus 100 may use a GPU when performing the coupling operation of S1925.

The electronic apparatus 100 may obtain converting data by performing a first color space conversion on the coupling data (S1930). The first color space conversion may include an operation of converting the pixel information of the second color space into the pixel information of the first color space.

In one example, the electronic apparatus 100 may perform the first color space conversion by using an NPU.

In one example, the electronic apparatus 100 may perform the first color space conversion based on a color space lookup table 631.

In one example, the electronic apparatus 100 may perform the first color space conversion by using first function information 611.

In one example, the electronic apparatus 100 may perform the first color space conversion by using the first function information 611 through the NPU. The electronic apparatus 100 may generate a color space lookup table 631 as a result of performance of the first color space conversion. The color space lookup table 631 may be updated based on results of performance of a new first color space conversion. The color space lookup table 631 may be used for the first color space conversion.

The electronic apparatus 100 may obtain fourth encoding data by encoding the converting data (S1935).

The electronic apparatus 100 may obtain final encoding data by merging the third encoding data and the fourth encoding data (S1940).

FIG. 20 is a view provided to explain an operation of obtaining final encoding data in a case where a target ratio is less than a threshold ratio, according to an embodiment.

FIG. 20 may illustrated an embodiment of obtaining final encoding data based on the operations of FIG. 19.

The electronic apparatus 100 may obtain a video frame 2010 and a UI frame 2020. The electronic apparatus 100 may receive a control instruction for outputting the video frame 2010 and the UI frame 2020 together.

The electronic apparatus 100 may identify a non-overlap video region 2011 that does not overlap the UI frame 2020 with respect to the video frame 2010.

The electronic apparatus 100 may identify an overlap video region 2012 that overlaps the UI frame 2020 with respect to the video frame 2010.

The electronic apparatus 100 may obtain a converting video region 2012-1 by performing a second color space conversion on the overlap video region 2012. The second color space conversion may include an operation of converting the pixel information of the first color space into the pixel information of the second color space. The electronic apparatus 100 may convert the pixel information of the first color space into the pixel information of the second color space, based on a color space lookup table 631.

The electronic apparatus 100 may obtain third encoding data 2013 by encoding the non-overlap video region 2011.

The electronic apparatus 100 may obtain a third rendering UI frame 2021 by performing UI rendering on the UI frame 2020. The UI rendering may include an operation of changing the UI frame 2020 for a coupling operation.

The electronic apparatus 100 may obtain coupling data 2030 by coupling the converting video region 2012-1 and the third rendering UI frame 2021. The electronic apparatus 100 may perform a coupling operation based on the second color space. In one example, the coupling operation may be described as a RGB coupling (RGB composition).

The electronic apparatus 100 may obtain converting data 2031 by performing a first color space conversion based on the coupling data 2030. The first color space conversion may include an operation of converting the pixel information of the second color space into the pixel information of the first color space. The electronic apparatus 100 may perform the first color space conversion based on the color space lookup table 631.

The electronic apparatus 100 may obtain fourth encoding data 2032 by encoding the converting data 2031.

The electronic apparatus 100 may obtain final encoding data 2040 by merging the third encoding data 2013 and the fourth encoding data 2032.

In one example, the video frame 2010, the non-overlap video region 2011, the overlap video region 2012, the third encoding data 2013, the converting data 2031, the fourth encoding data 2032 and the final encoding data 2040 may correspond to the first color space. Corresponding to the first color space may mean defining pixel information based on the first color space.

In one example, the UI frame 2020, the third rendering UI frame 2021 and the coupling data 2030 may correspond to the second color space. Corresponding to the second color space may mean defining pixel information based on the second color space.

In one example, the first color space may be YUV, and the second color space may be RGB.

In one example, the first color space may be YUVA, and the second color space may be RGBA.

In one example, the first color space may be YUV, and the second color space may be RGBA.

In one example, the first color space may be YUVA, and the second color space may be RGB.

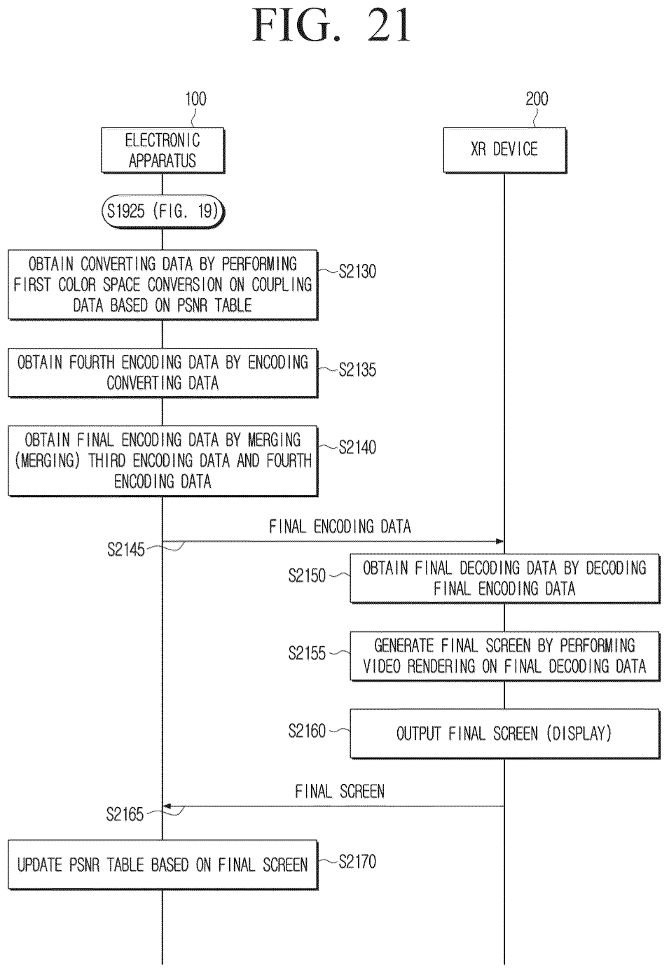

FIG. 21 is a view provided to explain an operation of updating a PNSR table through a screen output from an XR device, according to an embodiment.

The operations of FIG. 21 may be operations that are performed after S1925 of FIG. 19. The operations disclosed in FIG. 19 may also be applied to those of FIG. 21. Repetitive description is avoided.

The electronic apparatus 100 may be communicably connected with an XR device 200. The XR device 200 may be a device that outputs final encoding data provided by the electronic apparatus 100.

The electronic apparatus 100 may store a peak-signal to noise ratio (PSNR) table. The electronic apparatus 100 may obtain converting data by performing a first color space conversion on coupling data, based on the PSNR table (S2130).

The PSNR table may include information indicating video (or image) quality. The PSNR table may include information indicating a quality difference between original data and compressed (or encoded) data. The PSNR table may include a PSNR value measured based on a dB unit. The higher the PSNR value is, the better the quality is.

The electronic apparatus 100 may obtain fourth encoding data by encoding the converting data (S2135).

The electronic apparatus 100 may obtain final encoding data by merging third encoding data and the fourth encoding data (S2140).

The electronic apparatus 100 may transmit the final encoding data to an XR device 200 (S2145).

The XR device 200 may receive the final encoding data from the electronic apparatus 100. The XR device 200 may obtain final decoding data by decoding the final encoding data (S2150). The XR device 200 may generate a final screen by performing video rendering on the final decoding data (S2155). The XR device 200 may output (or display) the final screen (S2160).

The XR device 200 may transmit the final screen to the electronic apparatus 100 (S2165). The XR device 200 may transmit information on the final screen to the electronic apparatus 100. The information of the final screen may include pixel information indicating the final screen. The final screen may be described as an image frame corresponding to the final screen, image information corresponding to the final screen or image data corresponding to the final screen.

The electronic apparatus 100 may receive the final screen (or information on the final screen) from the XR device 200. The electronic apparatus 100 may update the PSNR table based on the final screen.

The electronic apparatus 100 may perform a first color space conversion on coupling data based on the updated PSNR table.

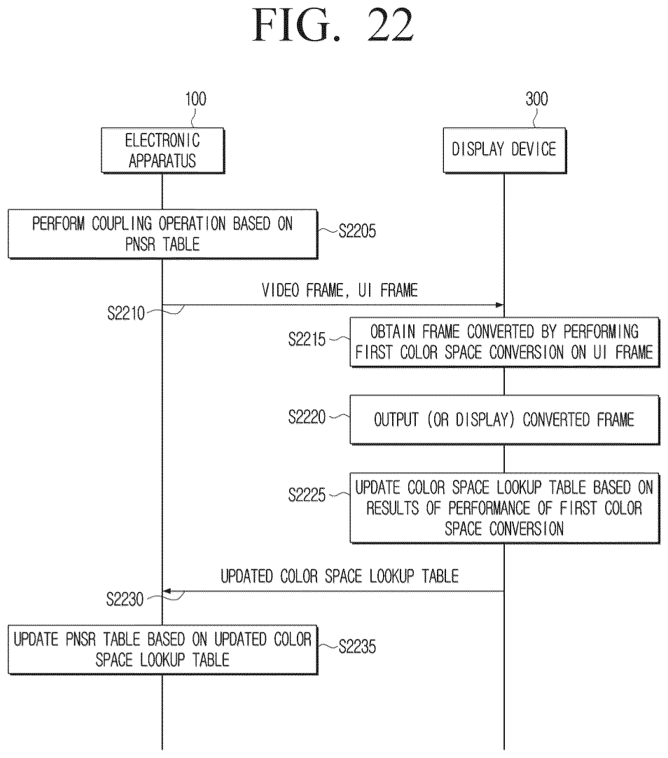

FIG. 22 is a view provided to explain an operation of updating a PSNR table based on a color space lookup table transmitted from an external display device, according to an embodiment.

Referring to FIG. 22, the electronic apparatus 100 may be communicably connected with a display device 300.

In one example, the electronic apparatus 100 may be communicably connected with the display device 300 further, in addition to the XR device 200. The display device 300 may be a device that outputs contents (a video frame and a UI frame) apart from the XR device 200.

The electronic apparatus 100 may store a PSNR table. The electronic apparatus 100 may perform a coupling operation based on the PSNR table (S2205). The electronic apparatus 100 may transmit a video frame and a UI frame to the display device 300 (S2210).

The display device 300 may store a color space lookup table. The display device 300 may receive the video frame and the UI frame from the electronic apparatus 100. The display device 300 may obtain a frame converted by performing a first color space conversion on the UI frame (S2215).

The display device 300 may output (or display) the converted frame (S2220). The display device 300 may update the color space lookup table based on results of performance of the first color space conversion (S2225). The display device 300 may transmit, to the electronic apparatus 100, the color space lookup table updated (S2230).

The electronic apparatus 100 may receive the color space lookup table updated from the display device 300. The electronic apparatus 100 may update the PSNR table based on the color space lookup table updated (S2235).

The electronic apparatus 100 may perform a coupling operation based on the PSNR table updated. The coupling operation may denote the coupling operation of S1325 and/or S1340 of FIG. 13.

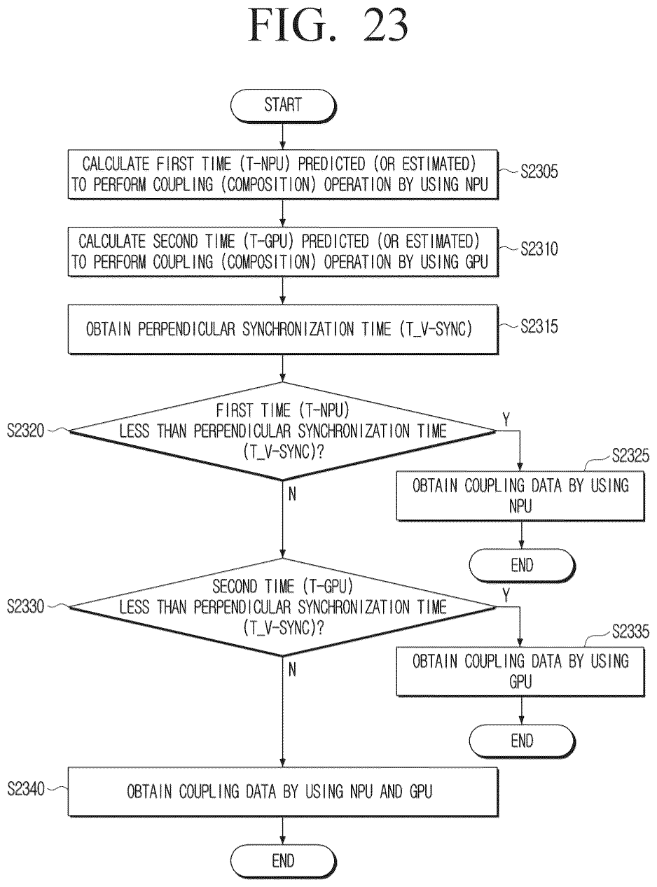

FIG. 23 is a view provided to explain an operation of selecting a processing unit performing a coupling operation based on perpendicular synchronization time, according to an embodiment.

S2305, and S2310 in FIG. 23 may correspond to S1705, and S1710 of FIG. 17. Repetitive description is avoided.

The electronic apparatus 100 may obtain perpendicular synchronization time T_V-sync (S2315). The perpendicular synchronization time T_V-sync may denote time for synchronizing frame provision timepoint and frame display timepoint. The perpendicular synchronization time T_V-sync may be described as a screen update cycle or frame timing adjustment time or input delay time.

The electronic apparatus 100 may identify whether first time T_NPU is less than the perpendicular synchronization time T_V-sync (S2320).

In the case where the first time T_NPU is less than the perpendicular synchronization time T_V-sync (S2320-Y), the electronic apparatus 100 may obtain coupling data by using an NPU (S2325). The electronic apparatus 100 may perform the coupling operation by using the NPU.

Unless the first time T_NPU is less than the perpendicular synchronization time T_V-sync, the electronic apparatus 100 may identify whether second time T_GPU is less than the perpendicular synchronization time T_V-sync (S2330).

In the case where the second time T_GPU is less than the perpendicular synchronization time T_V-sync (S2330-Y), the electronic apparatus 100 may obtain coupling data by using a GPU (S2335). The electronic apparatus 100 may perform the coupling operation by using the GPU.

Unless the second time T_GPU is less than the perpendicular synchronization time T_V-sync (S2330-N), the electronic apparatus 100 may obtain coupling data by using both the NPU and GPU (S2340). The electronic apparatus 100 may perform the coupling operation by using both the NPU and GPU. Part of a plurality of operations performed in the coupling operation may be performed through the NPU. The remaining operations may be performed through the GPU.

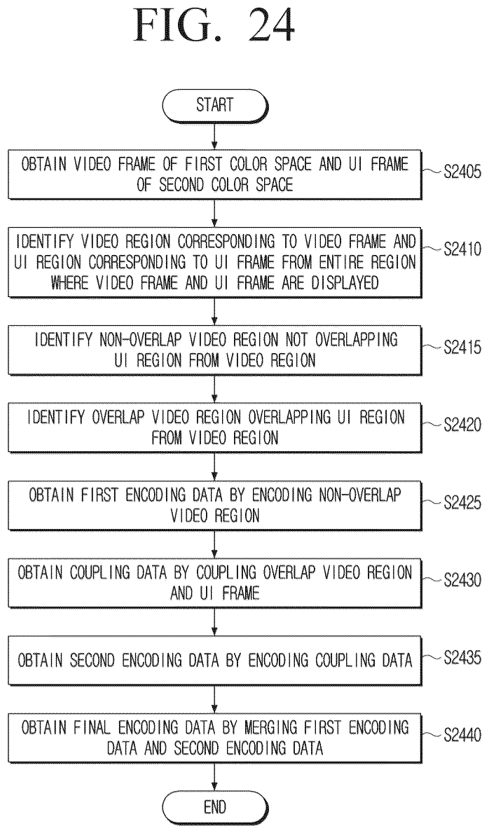

FIG. 24 is a view provided to explain a control method of an electronic apparatus, according to an embodiment.

Referring to FIG. 24, a control method of an electronic apparatus 100 includes obtaining a video frame of a first color space and a UI frame of a second color space (S2405), identifying a video region corresponding to the video frame and a UI region corresponding to the UI frame from an entire region in which the video frame and the UI frame are displayed (S2410), identifying a non-overlap video region that does not overlap the UI region from the video region (S2415), identifying an overlap video region that overlaps the UI region from the video region (S2420), obtaining first encoding data by encoding the non-overlap video region (S2425), obtaining coupling data by coupling the overlap video region and the UI frame (S2430), obtaining second encoding data by encoding the coupling data (S2435), and obtaining final encoding data by merging the first encoding data and the second encoding data (S2445).

The operation of identifying the video region and the UI region (S2410) may include dividing the video frame and the UI frame into predetermined blocks, and based on a plurality of the divided blocks, identifying the video region and the UI region.

The control method may include identifying a first ratio occupied by the video region in the entire region, obtaining a second ratio occupied by the UI region in the entire region, and obtaining a target ratio based on dividing the first ratio by the second ratio, and the operation of obtaining coupling data (S2430) may include obtaining coupling data based on the target ratio.

The control method may include identifying whether video rendering of converting the second color space into the first color space is possible, in the case where the target ratio is equal to or greater than a threshold ratio, and the operation of obtaining coupling data (S2430) may include obtaining coupling data by applying the video rendering to the UI frame in the case where the video rendering is possible, and obtaining coupling data by applying UI rendering to the UI frame in the case where the video rendering is impossible.

The operation of obtaining coupling data (S2430) may include obtaining a first rendering UI frame by performing the video rendering to the UI frame, in the case where the video rendering is possible, and obtaining coupling data by coupling the overlap video region and the first rendering UI frame.

The operation of obtaining coupling data (S2430) may include obtaining a second rendering UI frame by performing the UI rendering on the UI frame in the case where the video rendering is impossible, obtaining a converting UI frame by performing a first color space conversion on the second rendering UI frame, and obtaining coupling data by coupling the overlap video region and the converting UI frame.

The first color space conversion may include an operation of converting pixel information of the second color space into pixel information of the first color space.

The control method may include identifying whether the video frame is a 2D image, and unless the video frame is a 2D image, performing 2D modeling on the video frame.

The first color space may be YUV or YUVA, and the second color space may be RGB or RGBA.

The control method may include transmitting final encoding data to an extended reality (XR) device.

Embodiments of the method and device described herein improve the functioning of a computer by enhancing the display and UI capabilities of the computer. These problems are present in the realm of computation and networks. Thus, embodiments herein are rooted in computer technology to overcome a problem arising in the realm of computer networks.

Methods according to various embodiments of the present disclosure, described above, may be realized in an application form installable in exiting electronic apparatuses.

Methods according to various embodiments of the present disclosure, described above, may be implemented by upgrading software or hardware with respect to existing electronic apparatuses.

Various embodiments of the present disclosure, described above, may performed through an embedded server provided in an electronic apparatus, or an external server of at least one of an electronic apparatus or a display device.

According to embodiments, the embodiments described above may be implemented with software including instructions stored in a storage medium readable by a machine (e.g., a computer). The machine, as a device capable of calling the stored instructions from the storage media and operating according to the called instructions, may include the electronic apparatus according to the disclosed embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” only means that the storage medium includes no signal and is tangible, while the term does distinguish semi-permanent or temporary storage of data in the storage medium.

According to embodiments, the method in various embodiments described above may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store. In the case of online distribution, at least a portion of the computer program product may be stored at least temporarily, or generated temporarily in a storage medium such as a server of a manufacturer, a server of an application store, or memory of a relay server.

In addition, each of the elements (e.g., a module or a program) according to various described above may be composed of a single entity or a plurality of entities, and some of the corresponding sub elements described above may be omitted, or another sub element may be further included in the embodiments. Alternatively or additionally, some elements (e.g., modules or programs) may be integrated into one entity to perform identical or similar functions performed by each corresponding element prior to integration. Operations performed by a module, a program, or another element, according to the embodiments, may be performed sequentially, in parallel, repetitively, or heuristically, or at least some operations may be performed in a different order, omitted, or may add a different operation.

While example embodiments of the present disclosure are illustrated and described above, embodiments are not limited to the embodiments set forth herein, and certainly, various modifications thereof may be made by one skilled in the art to which the present disclosure pertains, without departing from the scope the disclosure claimed in the section of claims, and should not be understood as separating from the technical spirit of the disclosure.

What is claimed is:

1. An electronic apparatus comprising:
memory configured to store instructions; and
at least one processor comprising processing circuitry,
wherein the instructions, when executed by the at least one processor individually or collectively, cause the electronic apparatus to:
obtain a video frame of a first color space and a user interface (UI) frame of a second color space;
identify a video region corresponding to the video frame and a UI region corresponding to the UI frame from a display region in which the video frame and the UI frame are displayed;
identify a non-overlap video region from the video region that does not overlap the UI region;
identify an overlap video region from the video region that overlaps the UI region;
obtain first encoding data by encoding the non-overlap video region;
obtain combining data by combining the overlap video region and the UI frame;
obtain second encoding data by encoding the combining data; and
obtain final encoding data by merging the first encoding data and the second encoding data.

2. The electronic apparatus as claimed in claim 1, wherein the instructions, when executed by the at least one processor individually or collectively, further cause the electronic apparatus to:
divide the video frame and the UI frame into a plurality of blocks; and
based on the plurality of blocks, identify the video region and the UI region.

3. The electronic apparatus as claimed in claim 1, wherein the instructions, when executed by the at least one processor individually or collectively, further cause the electronic apparatus to:
identify a first ratio occupied by the video region in the display region;
identify a second ratio occupied by the UI region in the display region;
obtain a target ratio by dividing the first ratio by the second ratio; and
based on the target ratio, obtain the combining data.

4. The electronic apparatus as claimed in claim 3, wherein the instructions, when executed by the at least one processor individually or collectively, further cause the electronic apparatus to:
based on the target ratio being equal to or greater than a threshold ratio, identify whether video rendering of converting the second color space into the first color space is possible;
based on the video rendering being possible, obtain the combining data by applying the video rendering to the UI frame; and
based on the video rendering being impossible, obtain the combining data by applying UI rendering to the UI frame.

5. The electronic apparatus as claimed in claim 4, wherein the instructions, when executed by the at least one processor individually or collectively, further cause the electronic apparatus to:
based on the video rendering being possible, obtain a first rendering UI frame by performing the video rendering on the UI frame; and
obtain the combining data by combining the overlap video region and the first rendering UI frame.

6. The electronic apparatus as claimed in claim 4, wherein the instructions, when executed by the at least one processor individually or collectively, further cause the electronic apparatus to:
based on the video rendering being impossible, obtain a second rendering UI frame by performing the UI rendering on the UI frame;
obtain a converting UI frame by performing a first color space conversion on the second rendering UI frame; and
obtain the combining data by combining the overlap video region and the converting UI frame.

7. The electronic apparatus as claimed in claim 6, wherein the first color space conversion comprises converting pixel information of the second color space into pixel information of the first color space.

8. The electronic apparatus as claimed in claim 4, wherein the instructions, when executed by the at least one processor individually or collectively, further cause the electronic apparatus to:
identify whether the video frame is a two-dimensional (2D) image; and
based on the video frame being not a 2D image, perform 2D modeling on the video frame.

9. The electronic apparatus as claimed in claim 1, wherein the first color space is YUV or YUVA, and
wherein the second color space is RGB or RGBA.

10. The electronic apparatus as claimed in claim 1, further comprising:
a communication interface connected to an extended reality (XR) device,
wherein the instructions, when executed by the at least one processor individually or collectively, further cause the electronic apparatus to transmit the final encoding data to the XR device through the communication interface.

11. A control method of an electronic apparatus, the method comprising:
obtaining a video frame of a first color space and a user interface (UI) frame of a second color space;
identifying a video region corresponding to the video frame and a UI region corresponding to the UI frame from a display region in which the video frame and the UI frame are displayed;
identifying a non-overlap video region from the video region that does not overlap the UI region;
identifying an overlap video region from the video region that overlaps the UI region;
obtaining first encoding data by encoding the non-overlap video region;
obtaining combining data by combining the overlap video region and the UI frame;
obtaining second encoding data by encoding the combining data;
obtaining final encoding data by merging the first encoding data and the second encoding data; and
transmitting the final encoding data to a device for displaying an image based on the final encoding data.

12. The method as claimed in claim 11, wherein the identifying the video region and the UI region comprises:
dividing the video frame and the UI frame into a plurality of blocks; and
based on the plurality of the blocks, identifying the video region and the UI region.

13. The method as claimed in claim 11, further comprising:
identifying a first ratio occupied by the video region in the display region;
identifying a second ratio occupied by the UI region in the display region; and
obtaining a target ratio by dividing the first ratio by the second ratio,
wherein the obtaining the combining data comprises obtaining the combining data based on the target ratio.

14. The method as claimed in claim 13, further comprising:
based on the target ratio being equal to or greater than a threshold ratio, identifying whether video rendering of converting the second color space into the first color space is possible,
wherein the obtaining the combining data further comprises:
based on the video rendering being possible, obtaining the combining data by applying the video rendering to the UI frame; and
based on the video rendering being impossible, obtaining the combining data by applying UI rendering to the UI frame.

15. The method as claimed in claim 14, wherein the obtaining the combining data further comprises:
based on the video rendering being possible, obtaining a first rendering UI frame by performing the video rendering on the UI frame; and
obtaining the combining data by combining the overlap video region and the first rendering UI frame.

16. The method as claimed in claim 14, wherein the obtaining the combining data further comprises:
based on the video rendering being impossible, obtaining a second rendering UI frame by performing the UI rendering on the UI frame;
obtaining a converting UI frame by performing a first color space conversion on the second rendering UI frame; and
obtaining the combining data by combining the overlap video region and the converting UI frame.

17. The method as claimed in claim 16, wherein the first color space conversion comprises converting pixel information of the second color space into pixel information of the first color space.

18. The method as claimed in claim 14, further comprising:
identifying whether the video frame is a two-dimensional (2D) image; and
based on the video frame being not a 2D image, performing 2D modeling on the video frame.

19. The method as claimed in claim 11,
wherein the first color space is YUV or YUVA, and
wherein the second color space is RGB or RGBA.

20. The method as claimed in claim 11, further comprising:
transmitting the final encoding data to an extended reality (XR) device through a communication interface connected to the XR device.
